(19) United States
(12) Patent Application Publication
(10) Pub. No.: US 2010/0131331 A1
(43) Pub. Date: May 27, 2010

(54) COMPUTER IMPLEMENTED METHOD AND SYSTEM FOR THE AUTOMATED SELECTION, AGGREGATION, CAPTURE, ANALYSIS, AND PRESENTATION OF RESIDENTIAL AND COMMERCIAL REAL ESTATE INFORMATION

(76) Inventors: Allan Jay Ginsburg, Rockville, MD (US); David R. Murray, Windermere, FL (US)

Correspondence Address: DAVID R. MURRAY, 1332 GLENWICK DR, WINDERMERE, FL, 34786, US

(21) Appl. No.: 12/431,787

(22) Filed: Apr. 29, 2009

Related U.S. Application Data
(60) Provisional application No. 61/118,422, filed on Nov. 26, 2008.

(51) Int. Cl. G06Q 50/00; G01C 21/00; G06Q 10/00; G06Q 30/00; G06Q 40/00; G06N 5/02; G06F 17/30; G06F 17/40

(52) U.S. Cl. 705/10; 701/213; 705/27; 705/35; 705/36 R; 706/52; 707/E17.017; 707/E17.018; 707/E17.044

(57) ABSTRACT

The subject invention is directed to a computer implemented method and system for selecting and presenting information to buyers, sellers, and investors of residential or commercial real estate by licensed residential or commercial real estate agents in a user/server environment accessed through a Web site. The computer implemented method includes accessing a server through a Web site by a licensed residential or commercial real estate agent. The agent provides information relating to an existing or potential client's buying or selling criteria in order to create at least one residential or commercial data request. The data request is transmitted to a real estate Multiple Listing Service (MLS) for processing and the data is returned to the system Web site for presentation processing. The system compiles and organizes the data into a buyer, seller, or investor presentation including data reports, graphic displays, data explanations, and data summaries. The subject invention contains a Settlement Estimates module that does not require the user to be a licensed residential or commercial agent. The Settlement Estimates module estimates current property demand values, projected list prices, anticipated or projected offers, and seller net revenues received at settlement or buyer funds necessary to complete a transaction at settlement. The Settlement Estimates module is associated with specific properties in specific states and cities to account for the total investment necessary to finalize a transaction and account for the varying taxes and settlement closing fees relating to specific jurisdictions. Agents select print, file, or e-mail options for transmitting, delivering, or presenting the information to buyers, sellers or investors to support the client's decision making process. Non-agents may enter the Web site to access settlement information that does not require a residential or commercial real estate license and does not require access to the Multiple Listing Service. Both licensed agents and non-licensed users store the processed information and system outputs on the Web site for reference, updating, or comparative analysis.

### CROSS-REFERENCE TO RELATED APPLICATIONS

This application claims the priority of U.S. Provisional Application Ser. No. 61/118,422 entitled “A computer implemented method and system, Real E-Stats, for the automated selection, aggregation, capture, analysis, and presentation of residential and commercial real estate information accessed from one to many or all multiple listing services for licensed real estate agents, buyers or sellers of real estate, financial institutions, mortgage and investment lenders, media, and government agencies,” filed Nov. 26, 2008.

REFERENCES CITED

| | | |
|---|---|---|
| 4,429,385 | January 1984 | Cichelli, et al |
| 4,870,576 | September 1989 | Tornetto |
| 5,006,998 | April 1991 | Yasunobu, et al |
| 5,032,989 | July 1991 | Tornetta |
| 5,124,909 | June 1992 | Blakely, et al |
| 5,235,673 | August 1993 | Austvold, et al |
| 5,235,680 | August 1993 | Bijnagte |
| 5,237,157 | August 1993 | Kaplan |
| 5,309,355 | May 1994 | Lockwood |
| 5,361,195 | November 1994 | Shoquist, et al |
| 5,361,201 | November 1994 | Jost, et al |
| 5,414,621 | May 1995 | Hough |
| 5,452,468 | September 1995 | Peterson |
| 5,500,793 | March 1996 | Deming, Jr., et al |
| 5,573,747 | April 1071 | Adams |
| 5,584,025 | December 1996 | Keithley, et al |
| 5,664,115 | September 1997 | Fraser |
| 5,680,305 | October 1997 | Apgar, IV |
| 5,857,174 | January 1999 | Dugan |
| 5,960,407 | September 1999 | Vivona |
| 6,115,694 | September 2000 | Cheetham, et al |
| 6,141,684 | October 2000 | Bonissone, et al |
| 6,178,406 | January 2001 | Cheetham. Et al |
| 6,236,977 | May 2001 | Verba, et al |
| 6,401,070 | June 2002 | McManus, et al |
| 6,435,303 | September 2002 | Li |
| 6,484,176 | November 2002 | Sealand, et al |
| 6,519,618 | February 2003 | Snyder |
| 6,594,633 | July 2003 | Broerman |
| 6,609,109 | August 2003 | Bradley, et al |
| 6,609,118 | August 2003 | Khedkar, et al |
| 6,684,196 | January 2004 | Mini, et al |
| 6,748,369 | June 2004 | Khedkar, et al |
| 6,842,738 | January 2005 | Bradley, et al |
| 6,871,146 | March 2005 | Florance, et al |
| 6,883,002 | April 2005 | Faudman |
| 7,249,146 | July 2007 | Brecher |
| 7,305,328 | December 2007 | Fleming, et al |
| 20040143450 | July 2004 | Vidali |

### OTHER REFERENCES

Anandalingam, G. & Chen, L., “Linear Combination of Forecasts: A General Bayesian Model”, J. of Forecasting, July/September 1989, 8(3), pp. 199-214. cited by other.
Andrews, R. L. & Ferguson, J. T., “Integrating Judgment with Regression Appraisal”, Real Estate Appraiser and Analyst, Spring 1986, pp. 71-74. cited by other.
Armstrong, J. S., “Combining Forecasts: The End of the Beginning or the Beginning of the End?”, Int'l J. of Forecasting, 1989, 5, pp. 585-588. cited by other.
Bates, J. M. & Granger, C. W. J., “The Combination of Forecasts”, OR Quarterly, Operational Research Society, December 1969, 20(4), pp. 451-468. cited by other.
Bischoff, C. W., “The Combination of Macroeconomic Forecasts”, J. of Forecasting, July/September 1989, 8(3), pp. 293-314. cited by other.
Bunn, D., “Forecasting With More than One Model”, J. of Forecasting, July/September 1989, 8(3), pp. 161-166. cited by other.
Case, B. & Quigley, J. M., “The Dynamics of Real Estate Prices”, Rev. of Econ. & Stats., February 1991, 73(1), pp. 50-58. cited by other.
Clemen, R. T., “Combining Forecasts: A Review and Annotated Bibliography”, Int'l J. of Forecasting, 1989, 5, pp. 559-583. cited by other.
Diebold, F. X., “Forecast Combination and Encompassing: Reconciling Two Divergent Literatures”, Int'l J. Forecasting, 1989, 5, pp. 589-592. cited by other.
Flore, B. E. & White, E. M., “Subjective Versus Objective Combining of Forecasts: an Experiment”, J. of Forecasting, July/September 1989, 8(3), pp. 331-341. cited by other.
Gau, G. W. et al., “Optimal Comparable Selection and Weighting in Real Property Valuation: an Extension”, J. of the AREUEA, 1992, 20(1), pp. 107-123. cited by other.
Gilley, O. W. & Pace, R. K., “A Hybrid Cost and Market-Based Estimator for Appraisal”, J. of Real Estate Research, 1990, 5(1), pp. 75-88. cited by other.
Granger, C. W. J., “Forecasting in Business and Economics”, 2.sup.nd Edition, Academic Press, USA, 1989, pp. 153-165. cited by other.
Granger, C. W. J. & Newbold, P., “Forecasting Economic Time Series”, 2.sup.nd Edition, Academic Press, USA, 1986, pp. 265-276. cited by other.
Granger, C. W. J., “Invited Review: Combining Forecasts—Twenty Years Later”, J. of Forecasting, July/September 1989, 8(3), pp. 167-173. cited by other.
Granger, C. W. J. & Ramanathan, R., “Improved Method of Combining Forecasts”, J. of Forecasting, April/June 1984, 3(2), pp. 197-204. cited by other.
Guerard, J. B. Jr., “Composite Model Building for Foreign Exchange Rates”, J. of Forecasting, July/September 1989, 8(3) pp. 315-329. cited by other.
Guerard, J. B. Jr. & Clemen, R. T., “Collinearity and the Use of Latent Root Regression for Combining GNP Forecasts”, J. of Forecasting, July/September 1989, 8(3), pp. 231-238. cited by other.
Guerrero, V. M., “Optimal Conditional ARIMA Forecasts”, J. of Forecasting, July/September 1989, 8(3), pp. 215-229. cited by other.
Gunter, S. I. & Aksu, C., “N-Step Combinations of Forecasts”, J. of Forecasting, July/September 1989, 8(3), pp. 253-267. cited by other.
Hallman, J. & Kamstra, M., “Combining Algorithms Based on Robust Estimation Techniques and Co-Intergrating Restrictions”, J. of Forecasting, July/September 1989, 8(3), pp. 189-198. cited by other.
Hill, R. C. et al., “Estimating Capital Assed Price Indexes”, Rev. of Econ. and Stats., May 1997, 79(2), pp. 226-233. cited by other.
Hogarth, R. M., “On Combining Diagnostic ‘Forecasts’: Thoughts and Some Evidence”, Int'l J. of Forecasting, 1989, 5, pp. 593-597. cited by other.
Holden, K. & Peel, D. A., “Unbiasedness, Efficiency and the Combination of Economic Forecasts”, J. of Forecasting, July/September 1989, 8(3), pp. 175-188. cited by other.
Holden, K. et al., “Economic Forecasting: An Introduction”, 1989, Cambridge University Press, pp. 85-107. cited by other.
Knight, J. R. et al., “Biased Prediction of Housing Values”, J. of the AREUEA, 1992, 20(3), pp. 424-456. cited by other.
Lockwood, L. J. & Rutherford, R. C., “Determinants of Industrial Property Value”, Real Estate Economics, Summer 1996, 24(2), pp. 257-373. cited by other.
Maddala, G. S., “Econometrics”, 1977, McGraw-Hill, USA, pp. 314-317. cited by other.
Mahmoud, E., “Combining Forecasts: Some Managerial Issues”, Int'l J. of Forecasting, 1989, 5, pp. 599-600. cited by other.
Makridakis, S., “Why Combining Works?”, Int'l J. of Forecasting, 1989, 5, pp. 601-603. cited by other.
Oliveira, R. A., “Combining Forecasts to Predict Property Values for Single-Family Residences: Comment”, Land Economics, November 1978, 54(4), pp. 524-527. cited by other.
Pace, R. K. & Gilley, O. W., “Estimation Employing A Priori Information Within Mass Appraisal and Hedonic Pricing Models”, J. of Real Estate Finance & Economics, 1990, 3, pp. 55-72. cited by other.
Pace, R. K. & Gilley, O. W., “Appraisal Across Jurisdictions using Bayesian Estimation with Bootstrapped Priors for Secondary Mortgage Market Applications”, Prop. Tax j, March 1989, 8(1), pp. 27-42. cited by other.
Pereira, B. et al., “Experience in Combining Subjective & Quantitative Forecasts of Open Market Rates”, J. of Forecasting, 1989, 8(3), pp. 343-348. cited by other.
Quigley, J. M., “A Simple Hybrid Model for Estimating Real Estate Price Indexes”, J. Housing Econ., March 1995, 4(1), pp. 1-12. cited by other.
Raftery, A. et al., “Model Selection and Accounting for Model Uncertainty in Linear Regression Models”, Nov. 19, 1993, U of Washington, pp. 1-24. cited by other.
Sessions, D. N. & Chatterjee, S., “The Combining of Forecasts Using Recursive Techniques With Non-Stationary Weights”, J. of Forecasting, 1989, 8(3), pp. 239-251. cited by other.
Smith, D. G. C., “Combination of Forecasts in Electricity Demand Prediction”, J. of Forecasting, 1989, 8(3), pp. 349-356. cited by other.
Wall, K. D. & Correia, C., “A Preference-Based Method of Forecast Combination”, J. of Forecasting, 1989, 8(3), pp. 269-292. cited by other.
Winkler, R. L., “Combining Forecasts: A Philosophical Basis & Some Current Issues”, Int'l J. of Forecasting, 1989, 5, pp. 605-609. cited by other.
Wong, S. K. et al., “Estimating Age Effects in Repeat-Sales Price Indices”, Proc. Of 2.sup.nd Int'l Postgraduate Res. Conf. in the Built & Human Environ., April 2002, U of Salford, England, pp. 290-300. cited by other.
Wood, S., “Combining Forecasts to Predict Property Values for Single-Family Residences”, Land Economics, May 1976, 52(2), pp. 221-229. cited by other.
Wood, S., “Combining Forecasts to Predict Property Values for Single-Family Residences: Reply”, Land Economics, November 1978, 54(4), pp. 528-530. cited by other.

### FIELD OF THE INVENTION

The present invention relates generally to a computer implemented method and system for the automated selection of real estate listing data and the processing of the data into a presentation and proposal format, and more particularly to a computer implemented method and system for selecting and processing the information through a user/server environment accessed through a Web site. A result of the invention on a national scale delivers reports of national, regional, and state real estate activity on demand for executive users.

### BACKGROUND OF THE INVENTION

Real estate agents invest hours of their time searching Multiple Listing Service databases for data pertaining to real estate seller or buyer criteria. They search and compile data for either client presentations to attract new clients or update data to serve existing clients. While the overall demographics of real estate agents range from very young to mature, most agents tend to skew between the ages of 35 to 65 years of age. Most agents are less computer literate than more computer literate and lack the expertise necessary to perform statistical evaluations, projections, and graphic representations of the data, especially in an industry where time is of the essence. MyRealEstats delivers in minutes what an average real estate agent would require many hours to accomplish if the agent had the tools and training necessary to generate the outputs.

The Multiple Listing Service data base includes all or most of the data necessary to prepare for client presentations and research, but it can be difficult for users who do not have a comfort level with computer systems to generate the correct outputs and to format outputted data into reports, charts and graphic representations. Even though most real estate offices have programs available such as Microsoft Excel and PowerPoint, few agents have the skill sets necessary to utilize and program these tools to work with the Multiple Listing Service data.

Broadcasting outlets have similar issues. Audience measurement companies such as Arbitron survey markets across the country to identify listenership, but the data must be processed based on buyer and seller criteria to produce information. Data by itself is not information until it is in a format enabling the user to properly evaluate it. There are a number of systems that mine Arbitron data, analyze the data, and format it into presentation and proposal formats; Tapscan, Strata, and Arbitrends are prime examples. These programs were all designed to serve the needs of both broadcast advertising buyers and sellers. There exist a correlation between the activities of broadcast account executives and real estate agents. Both access sophisticated and complex databases in order to search the needs and requirements of their clients. Real Estate agents, unlike Broadcast Account Executives, do not have a resource or tool similar to Tapscan, Strata, or Arbitrends. The approximate 1,000,000 or more US real estate agents do not have a single system available to simplify the process of accessing, analyzing, organizing and formatting their Multiple Listing Service data into information and knowledge as do the estimated 50,000 radio account executives in the US.

### SUMMARY OF THE INVENTION

The subject invention is directed to a computer implemented method and system which contains modules that assist in residential and commercial real estate transactions from the early buyer/seller “what if” scenarios to ratification of the contract. The first module calculates the closing or settlement costs charged to real estate buyers or sellers to approximate the amount of cash required at “Closing” or “Settlement” by the buyer to complete the transaction, and the amount of cash, if any, the seller will net from the sell of the property. Calculations begin with the end of the transaction process to confirm that the buyer's budget is realistic and the homes considered are within the buyer's ability to purchase. Variables associated with the seller are calculated to assure that pricing and selling the property yield anticipated results. Beyond the initial “Settlement Estimates” the invention's second module furthers the process by providing methods and systems for the automated selection, aggregation, capture, analysis, and presentation of residential and commercial real estate information to assist in the completion of a real estate transaction. The information is accessed from a variety of sources including but not limited to location aware data such as neighborhood market trending and one to many multiple listing services accessed licensed real estate agents, financial institutions, mortgage and investment lenders, media, and government agencies, and others in a user/server environment accessed through a Web site

### DESCRIPTION OF THE DRAWINGS

The detailed description will refer to the following embodiments, wherein like numerals refer to like elements, and wherein:

FIG. 1 is an embodiment of the overall Real E-Stat system modules;

FIG. 2 is n embodiment of Access and Security;

FIG. 3 is an embodiment of process flow illustrating the routine for the query initiation;

FIG. 4 is an embodiment of process flow illustrating the routine for receiving and generating output;

FIG. 5 is an embodiment illustrating the Location Criteria Selection Screens for Sellers or Buyers with location aware data input;

FIG. 6 is an embodiment illustrating the output reports and graphics of the system beginning with the County and drilling down through the Zip Code, Geographic Area, Subdivision and Street;

FIGS. 7.1 through 7.16 are embodiments of output filtered and or arranged by Country, a Region, a State, a County, or Zip Code with graphic representations.

FIG. 8 illustrates an embodiment that illustrates output for Sale and houses Sold in the Area, Subdivision, and Street;

FIG. 9 illustrates embodiments for; 1) a graphic representation of the revenue or yield values of a Seller's house based on comparative statistical analysis and projections and 2) the subjective analysis table to adjust values based on house upgrades or downgrades and 3) the projected list price to yield the projected value based on the average list price yield of homes sold;

FIG. 10 illustrates an embodiment of the invention of Property Value Indexes;

FIGS. 11.1 through 11.6 illustrate embodiments of the Settlement Estimates module workspace;

FIG. 12 illustrates an embodiment of smart calculator module workspace;

FIG. 13 provides embodiments of the modules Weighted Average Index interaction with external data sources;

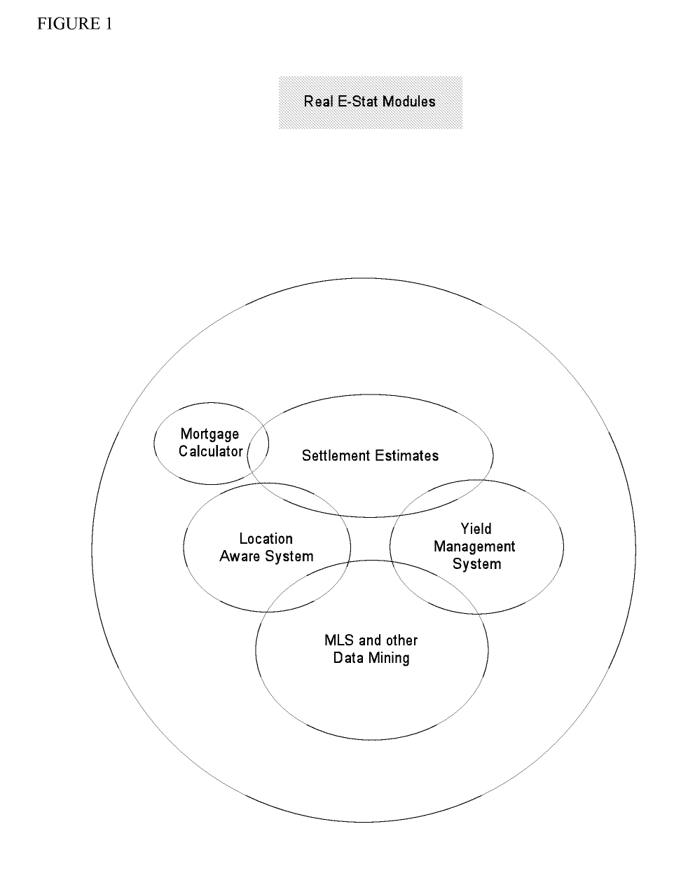

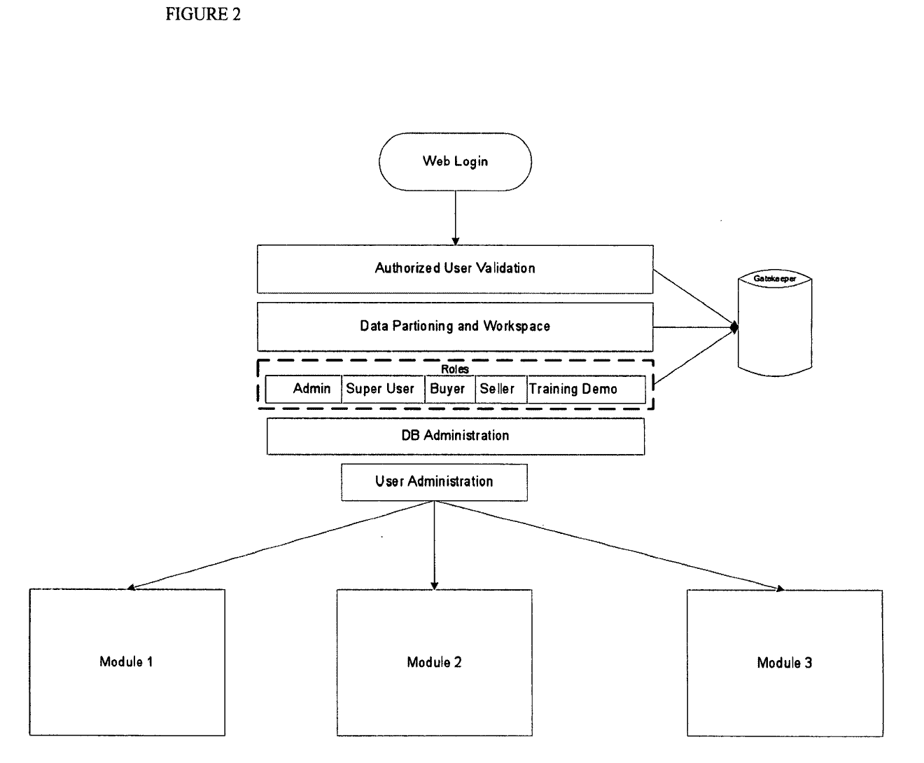

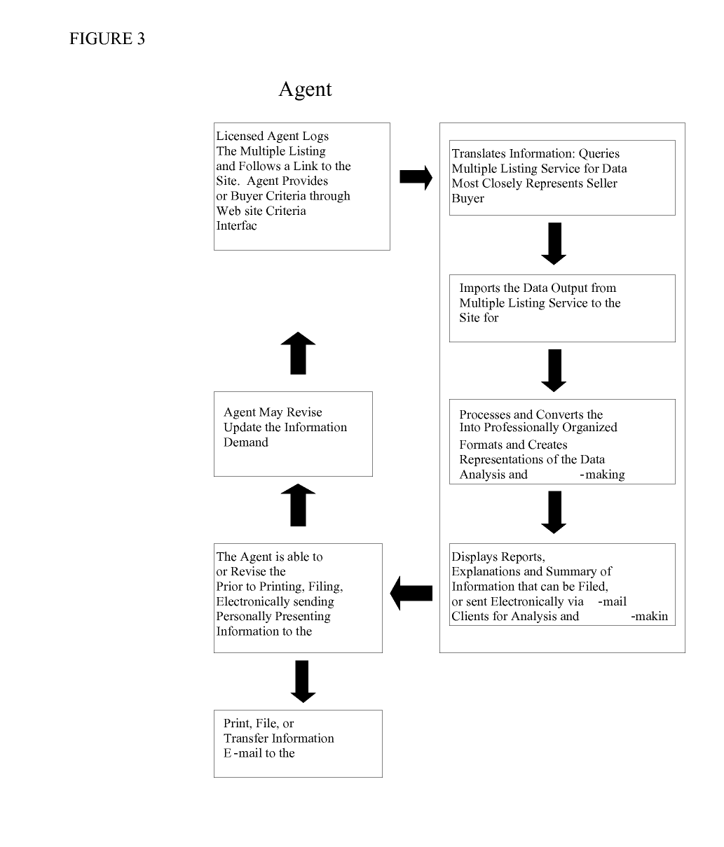

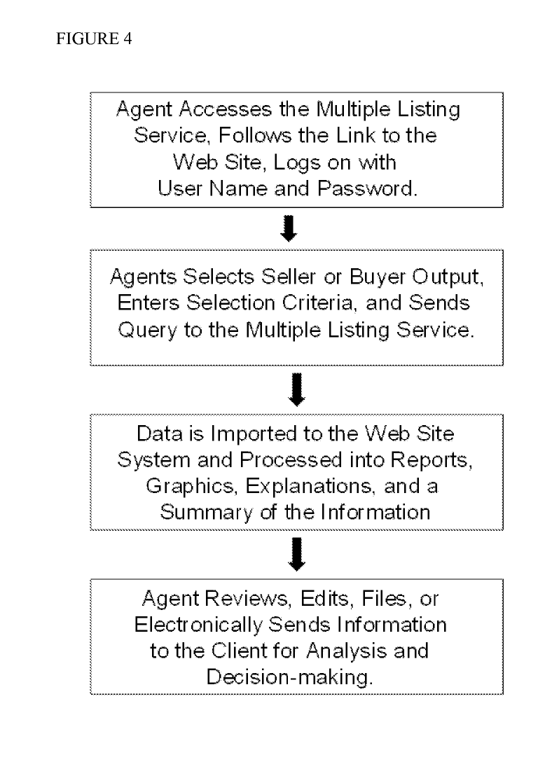

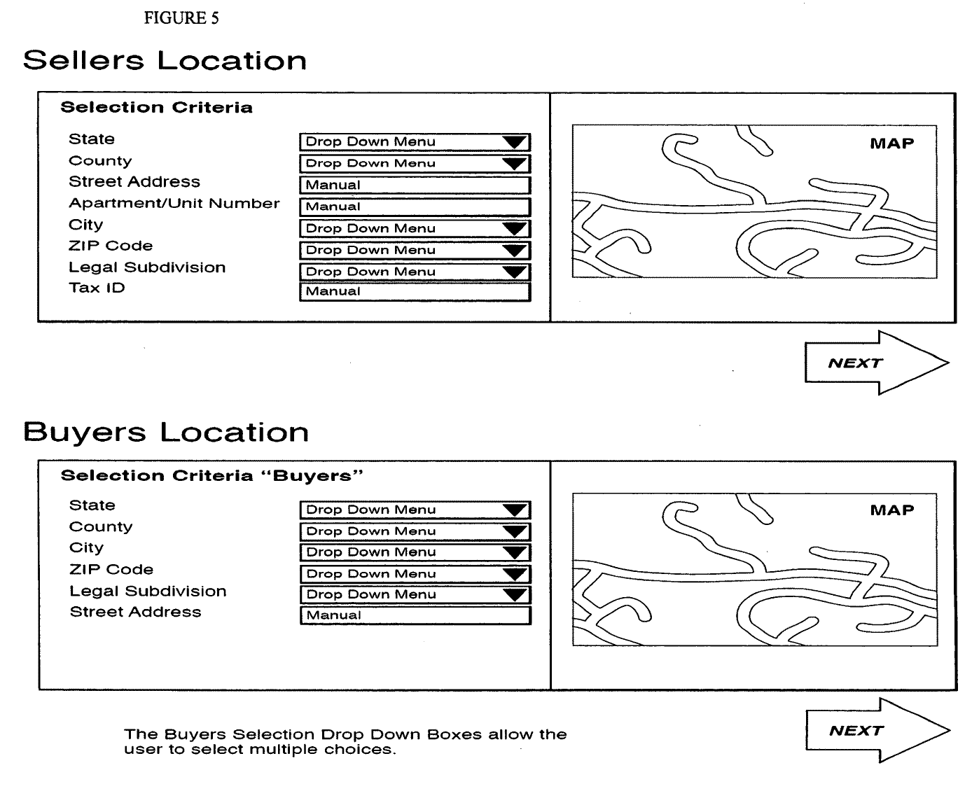

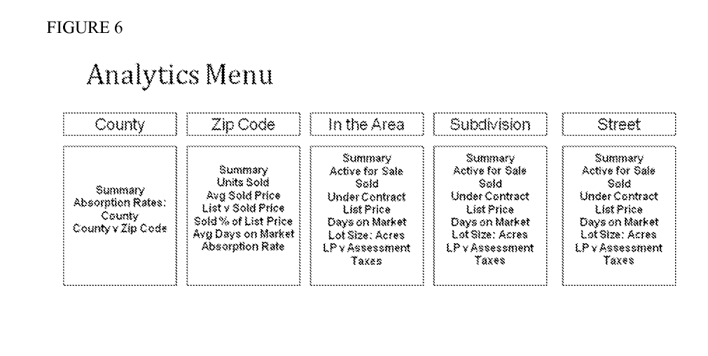

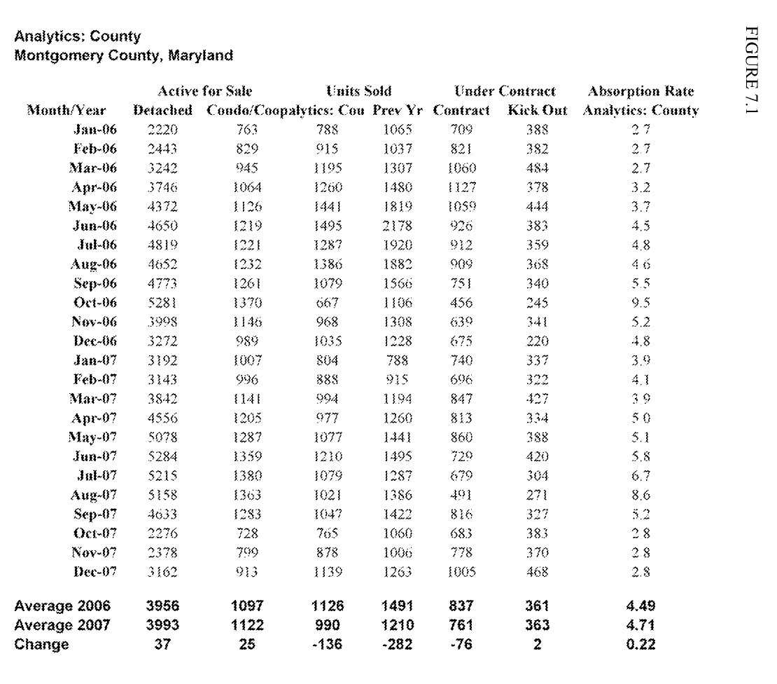

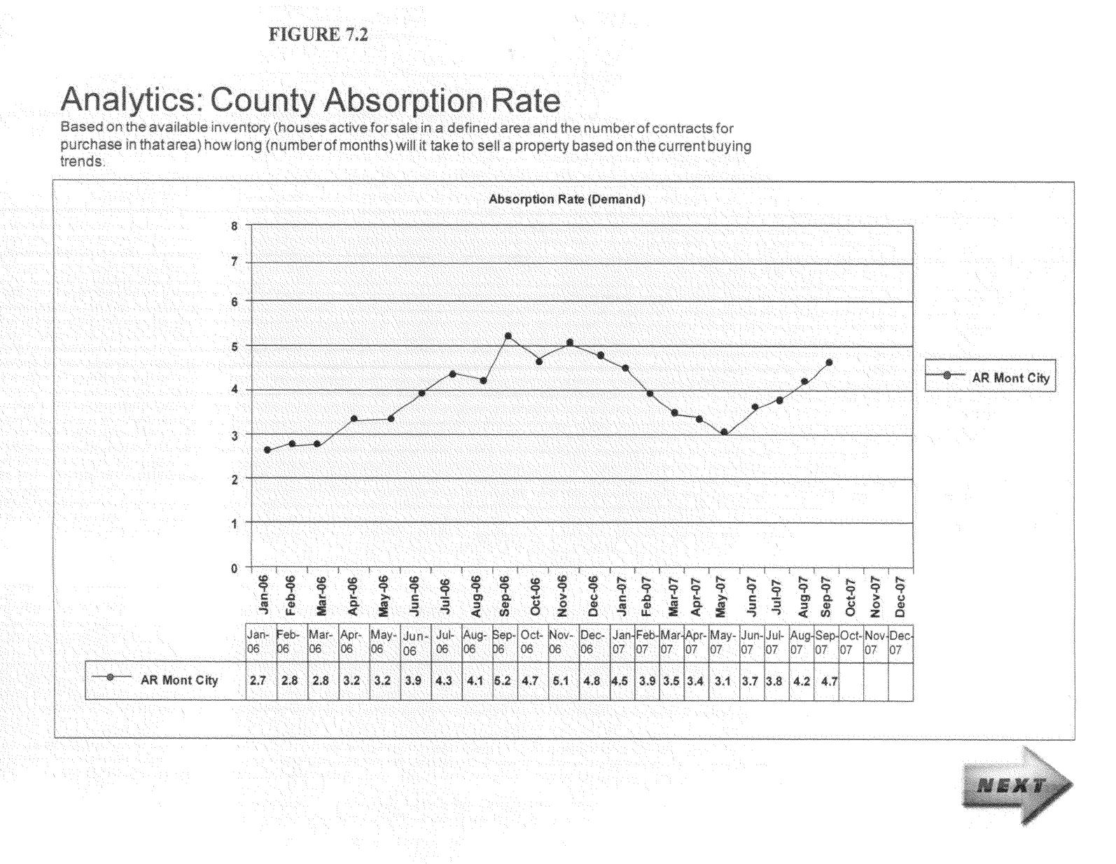

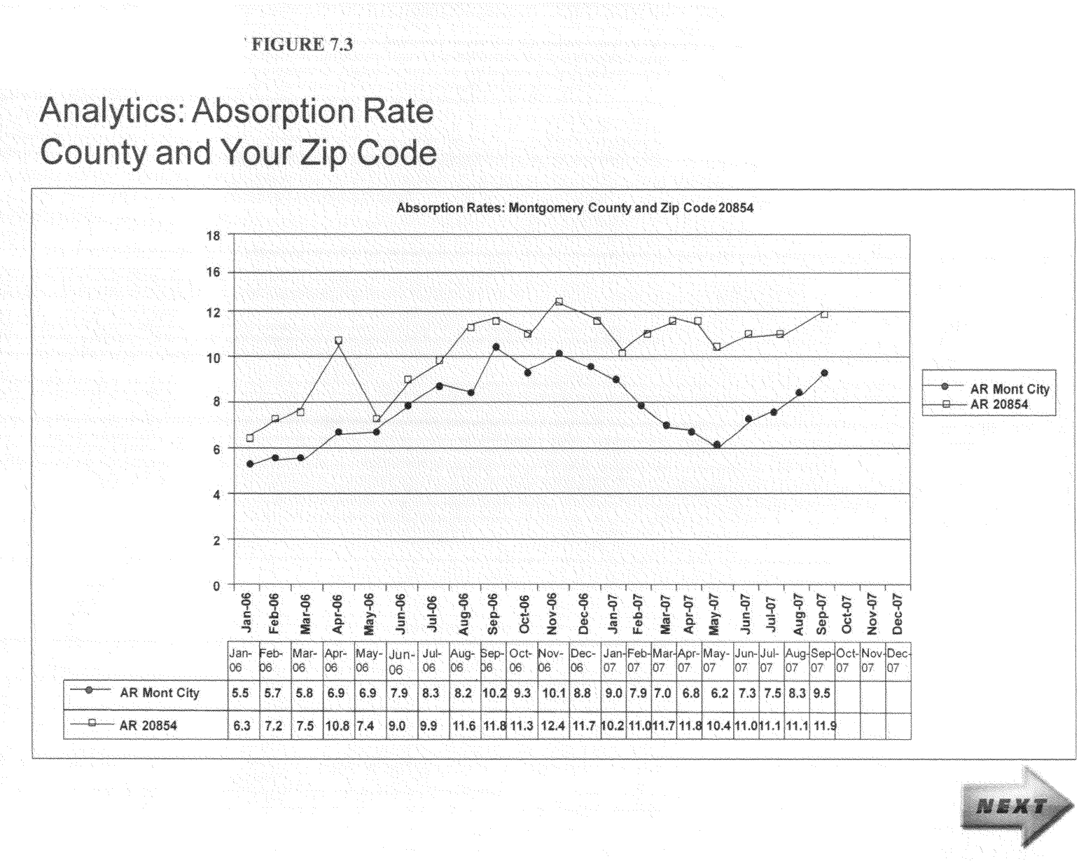

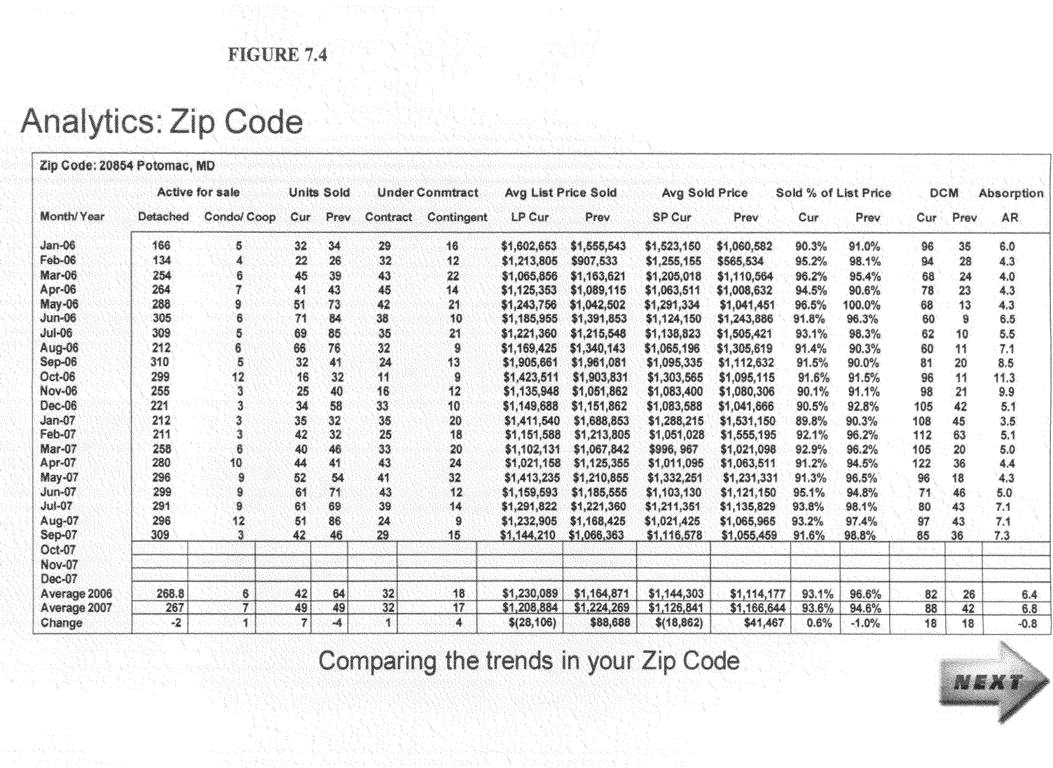

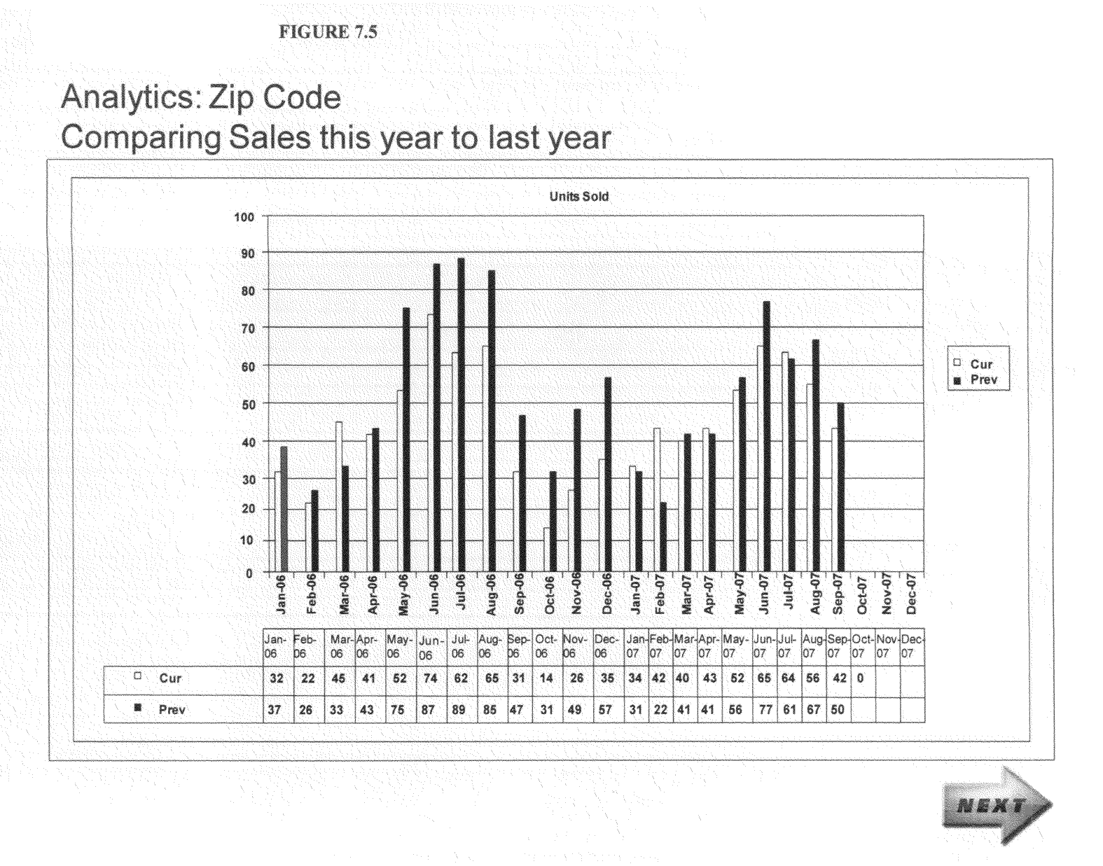

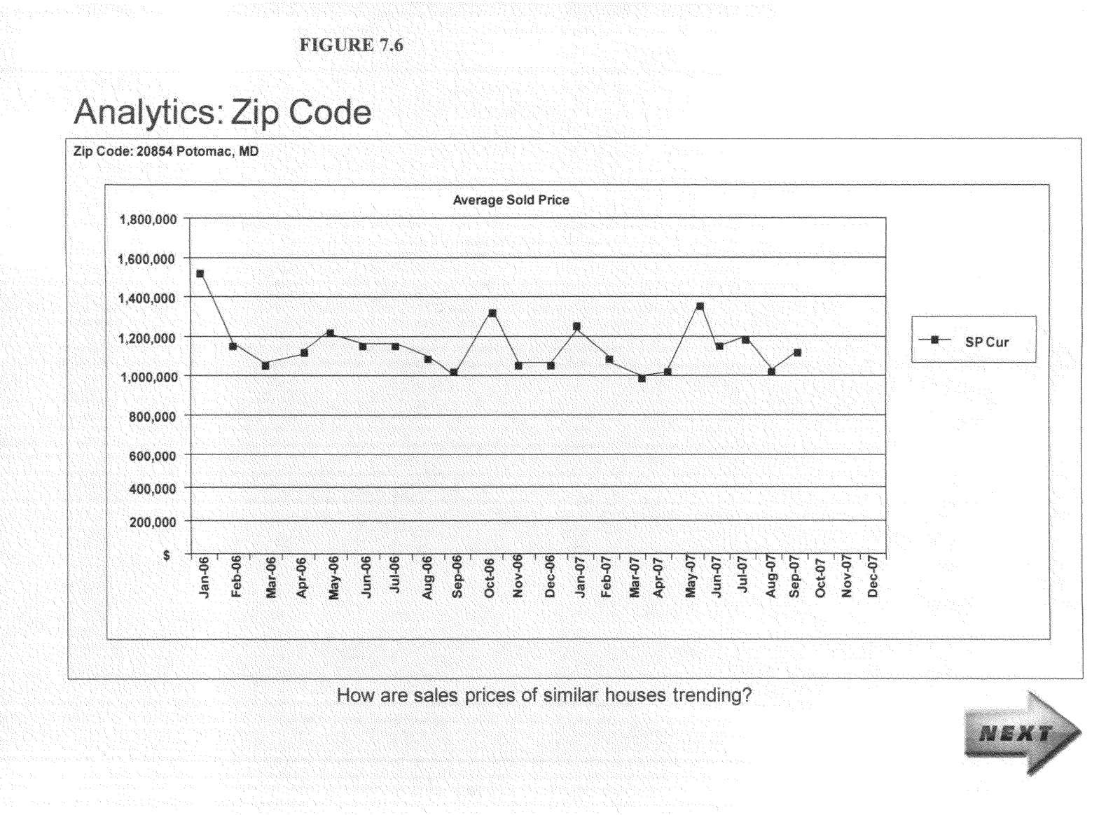

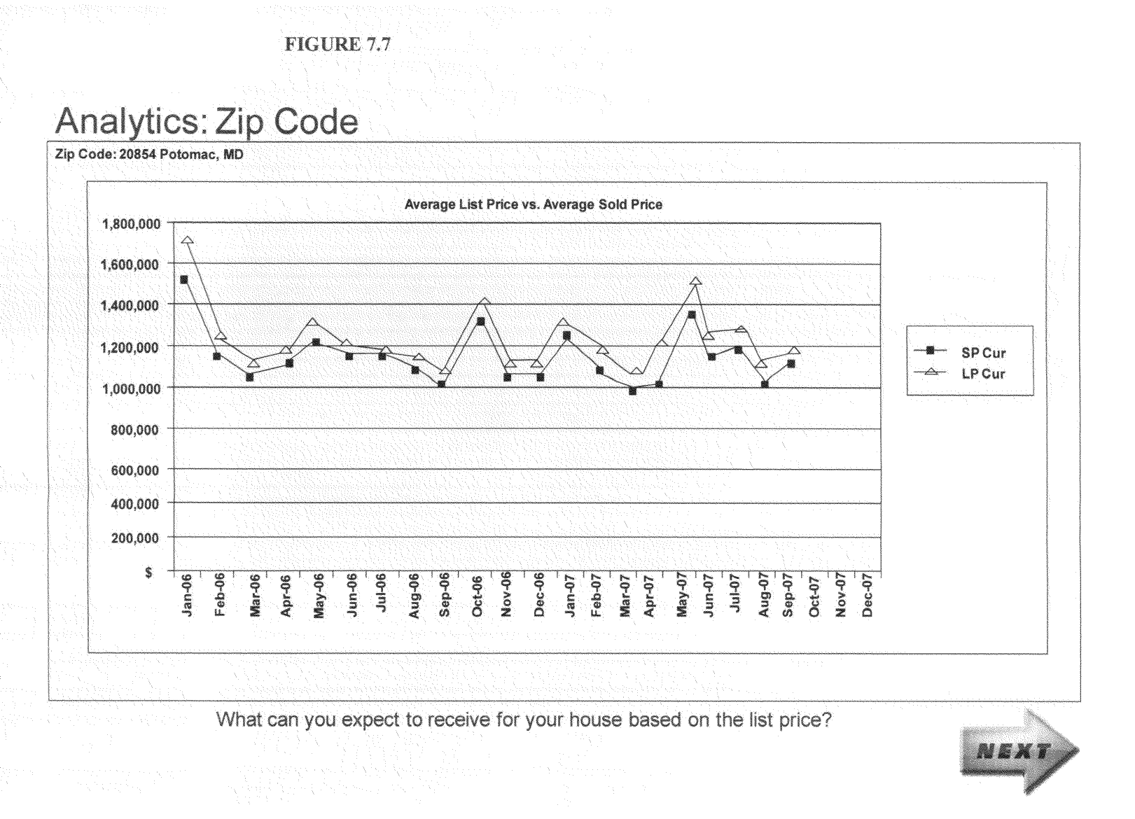

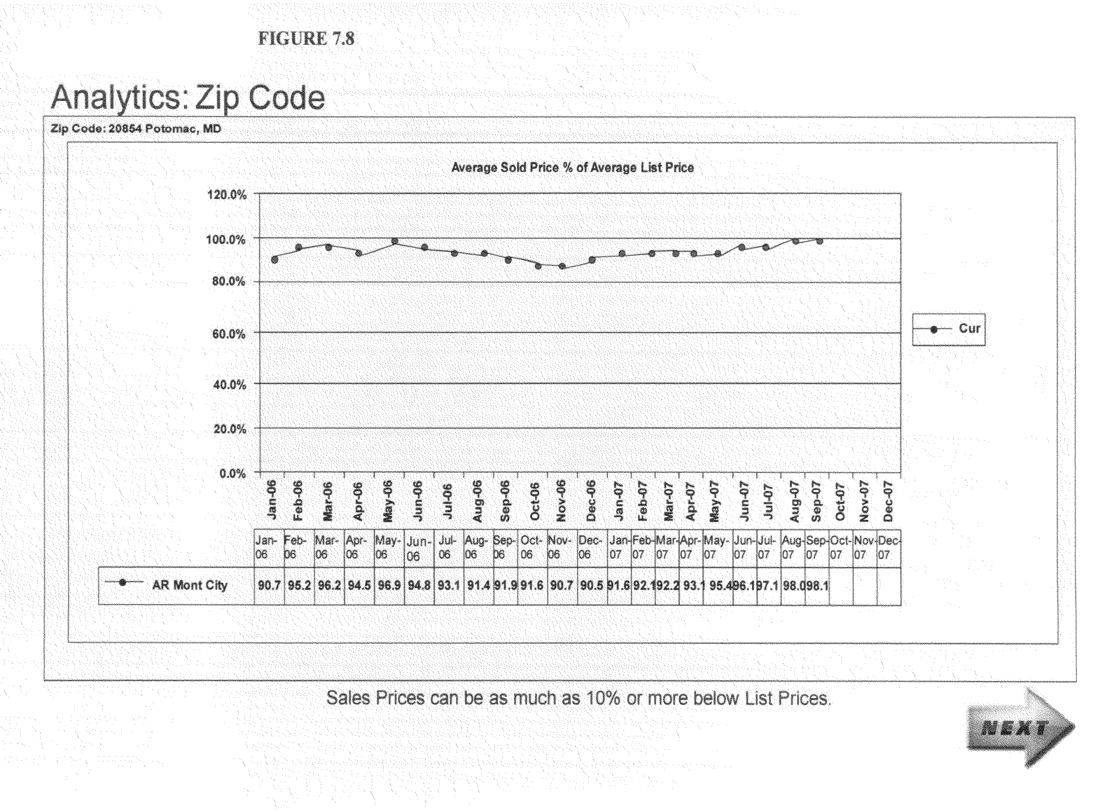

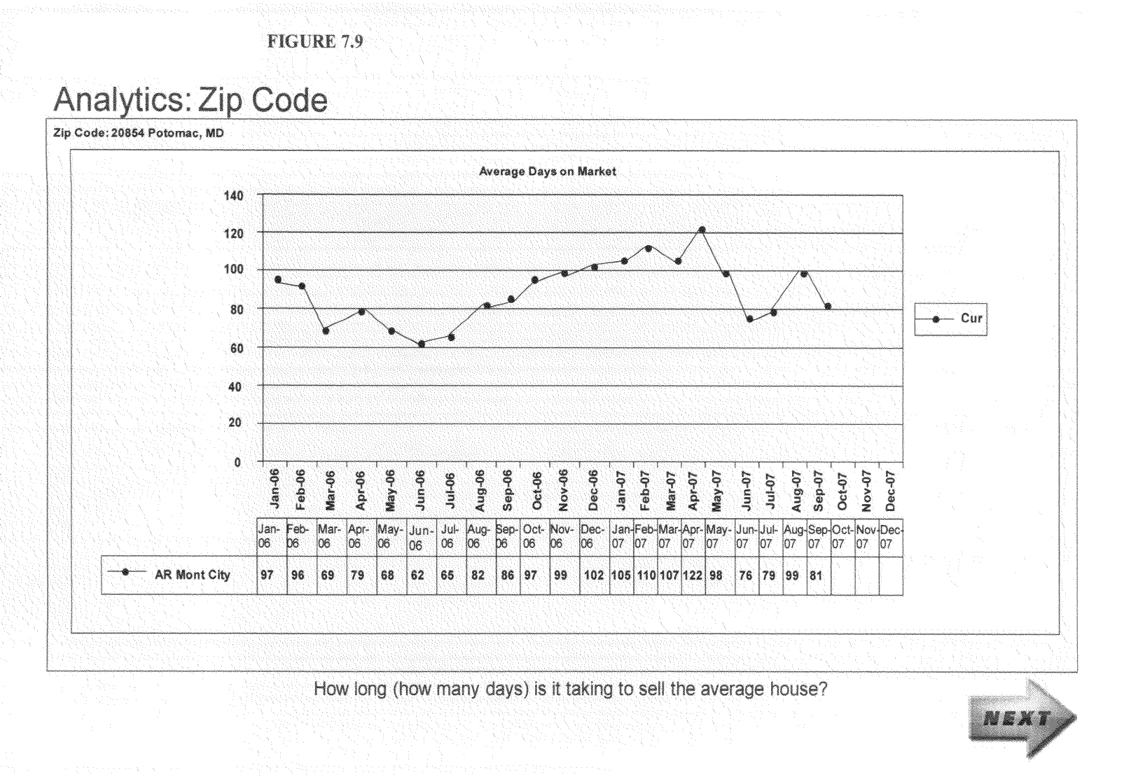

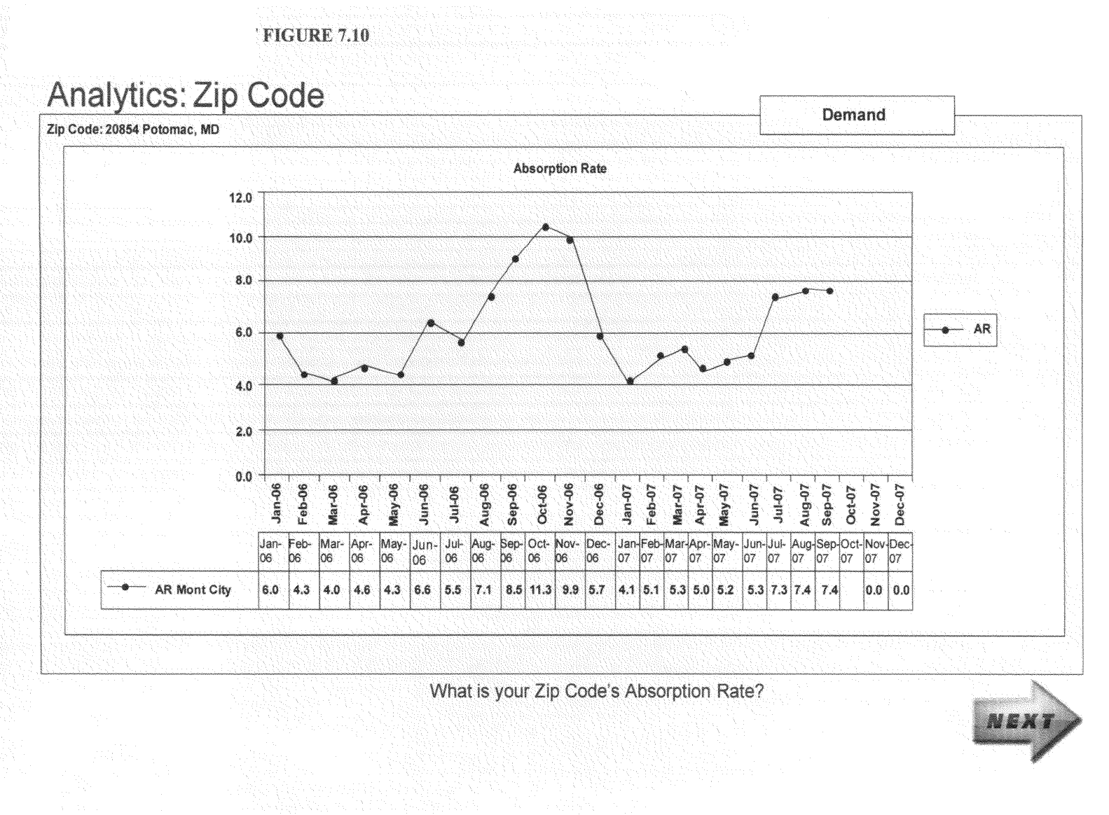

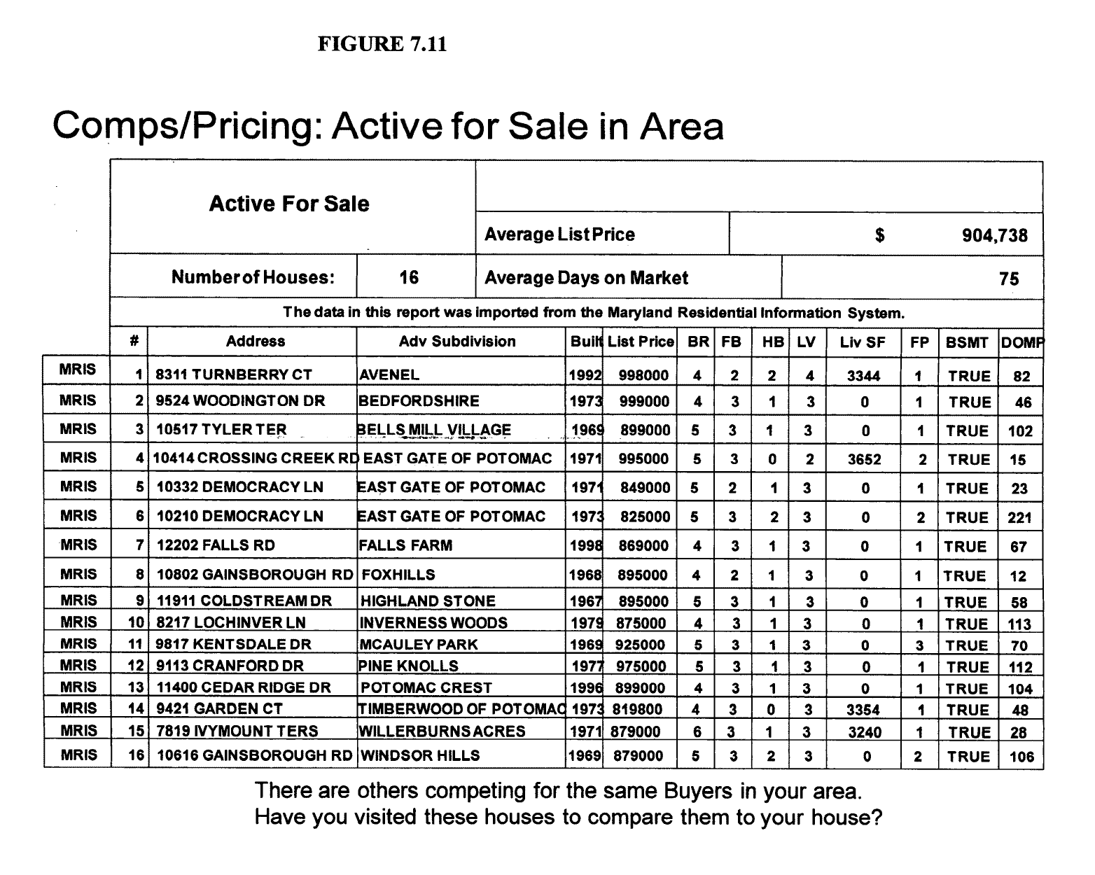

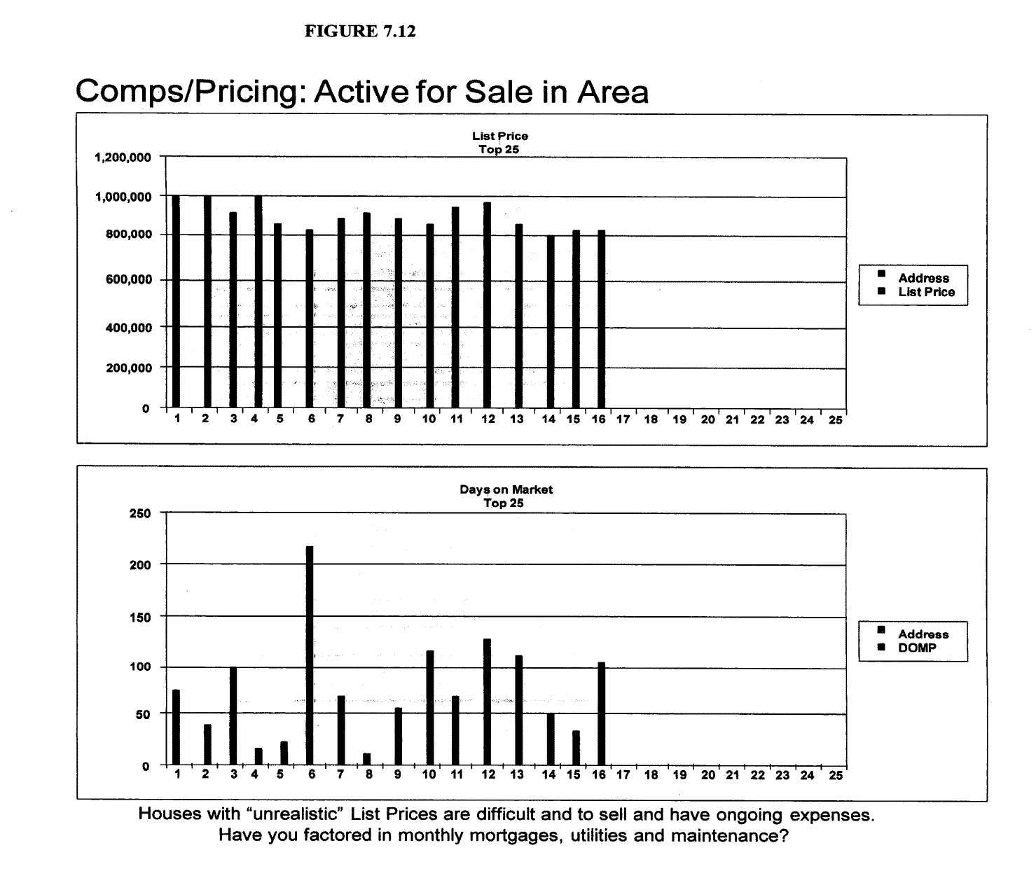

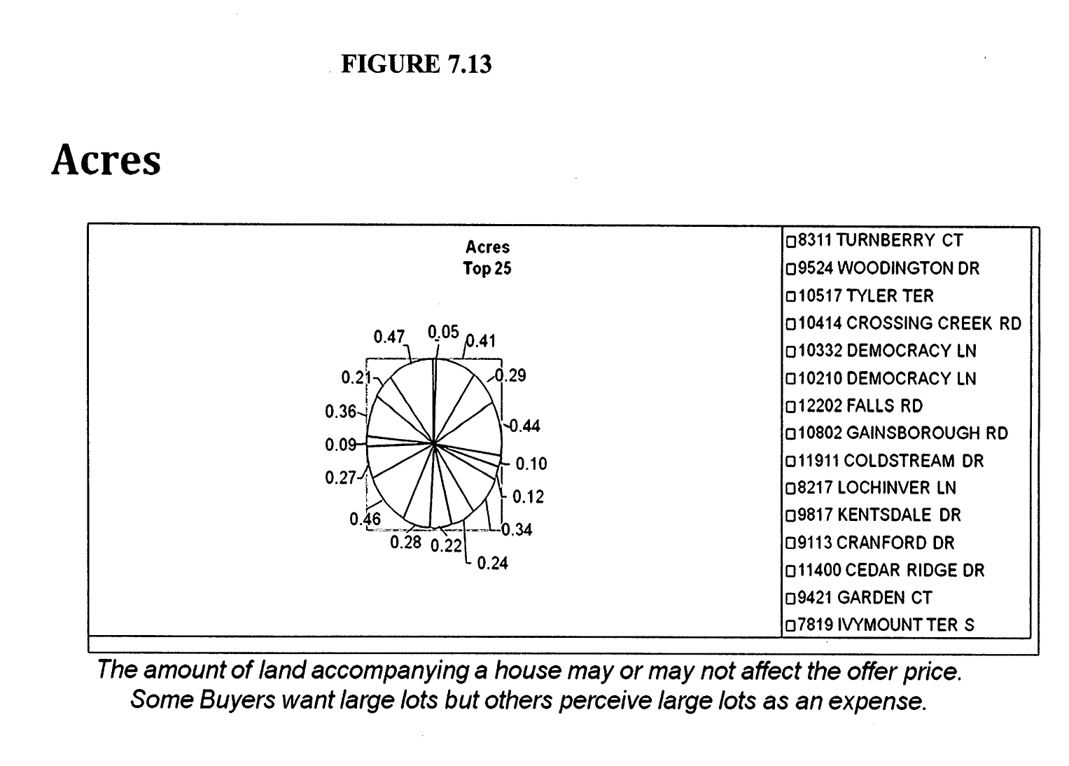

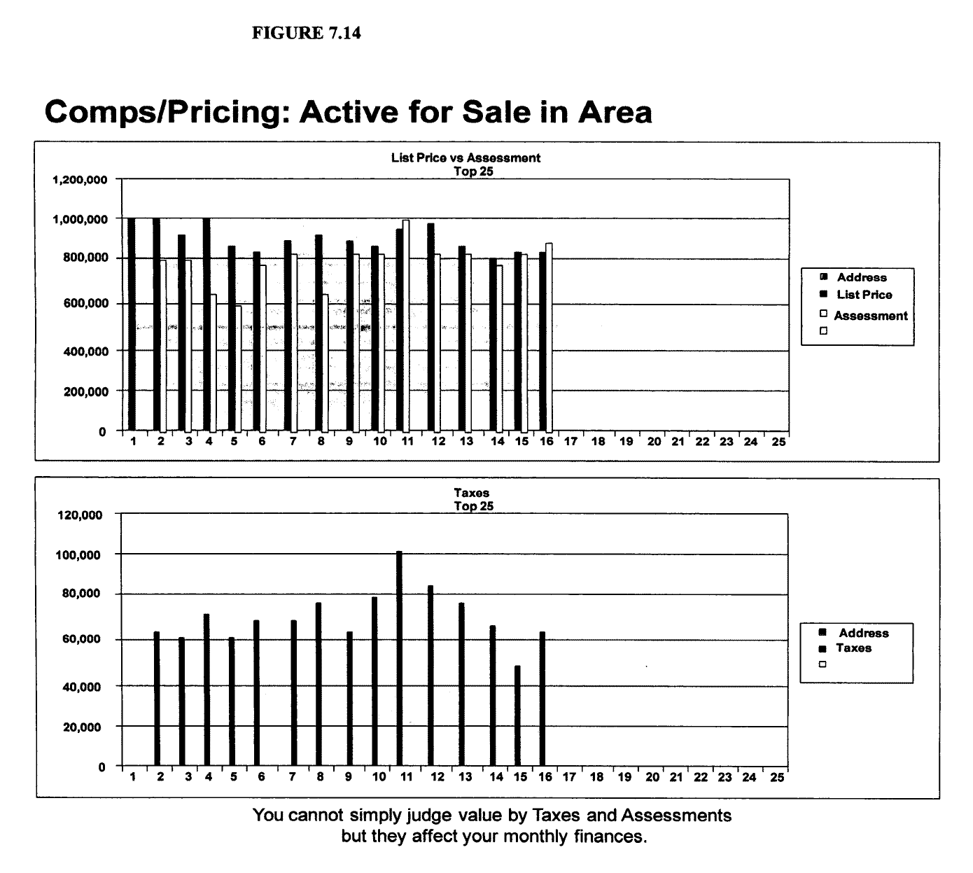

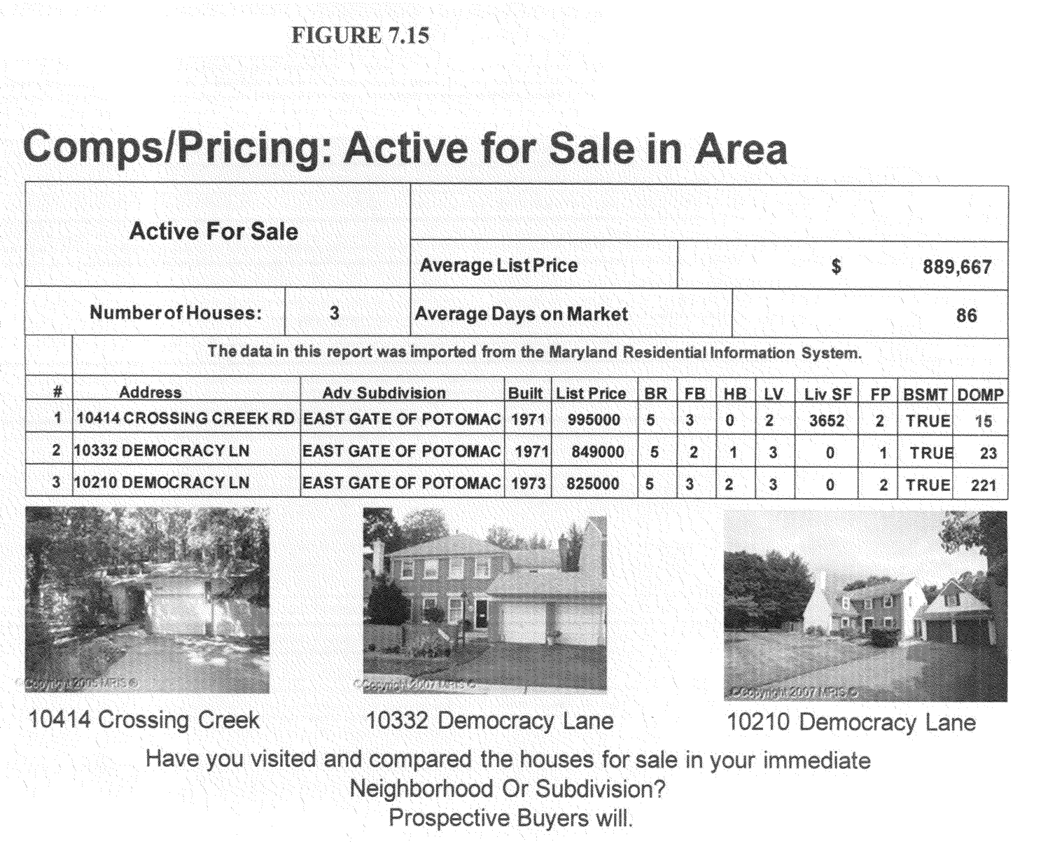

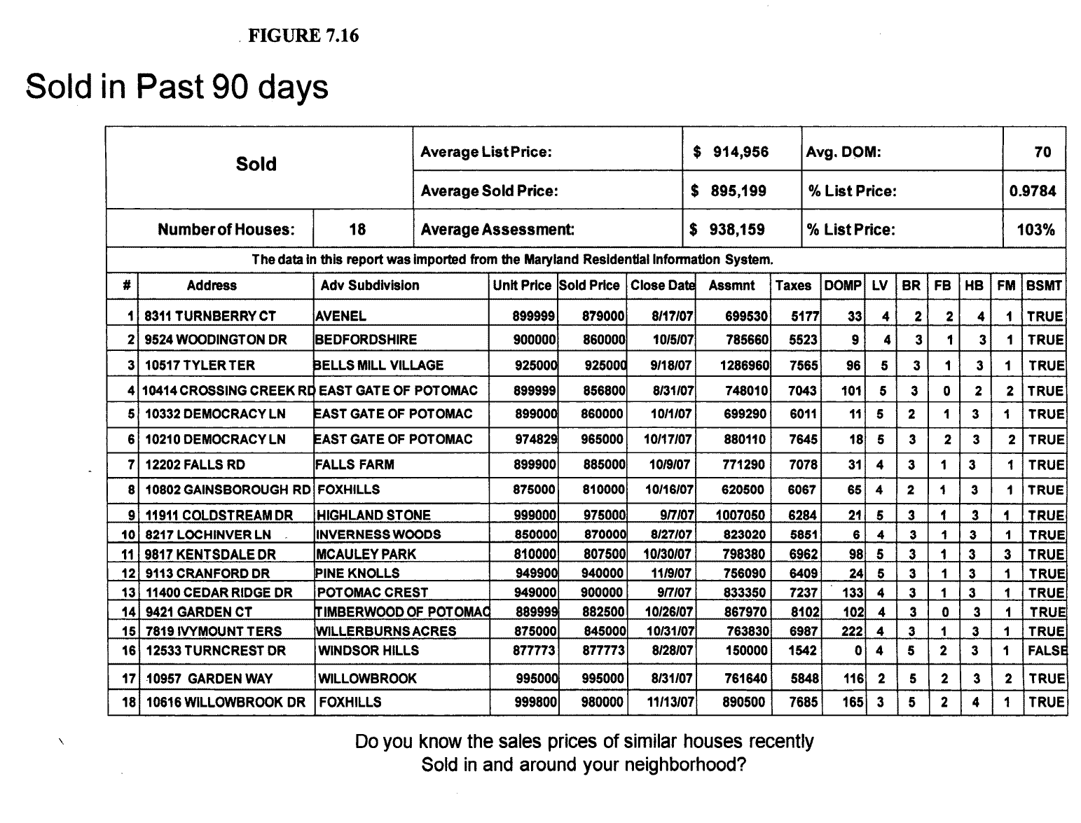

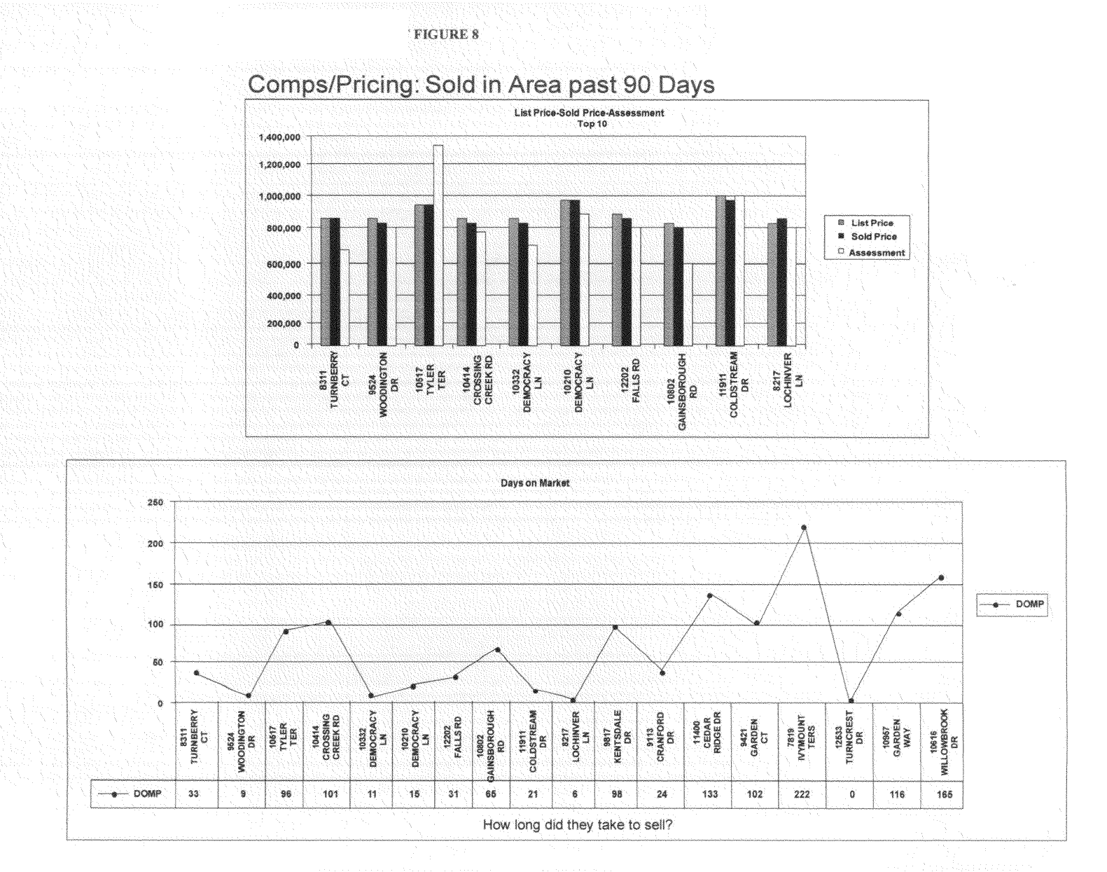

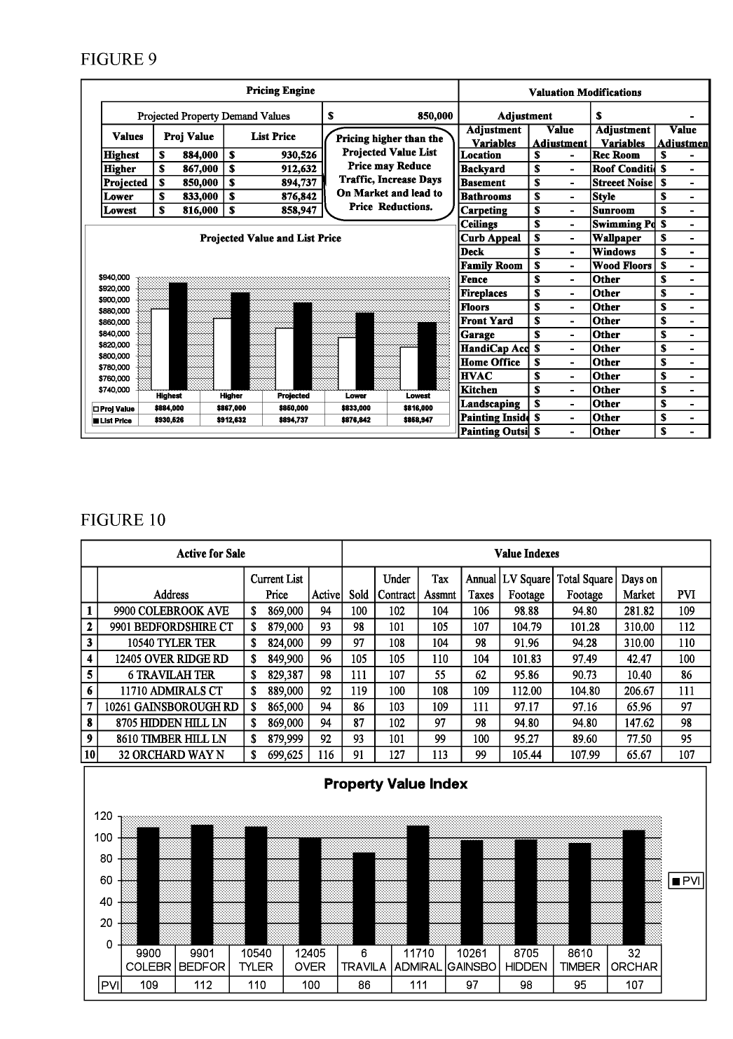

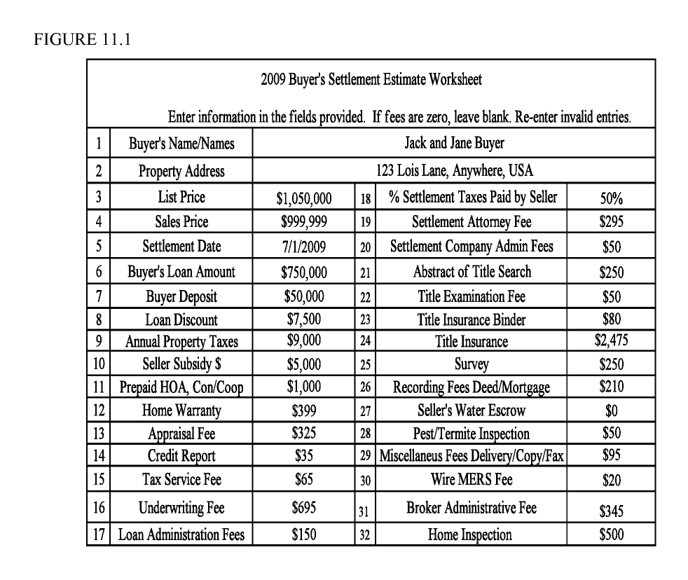

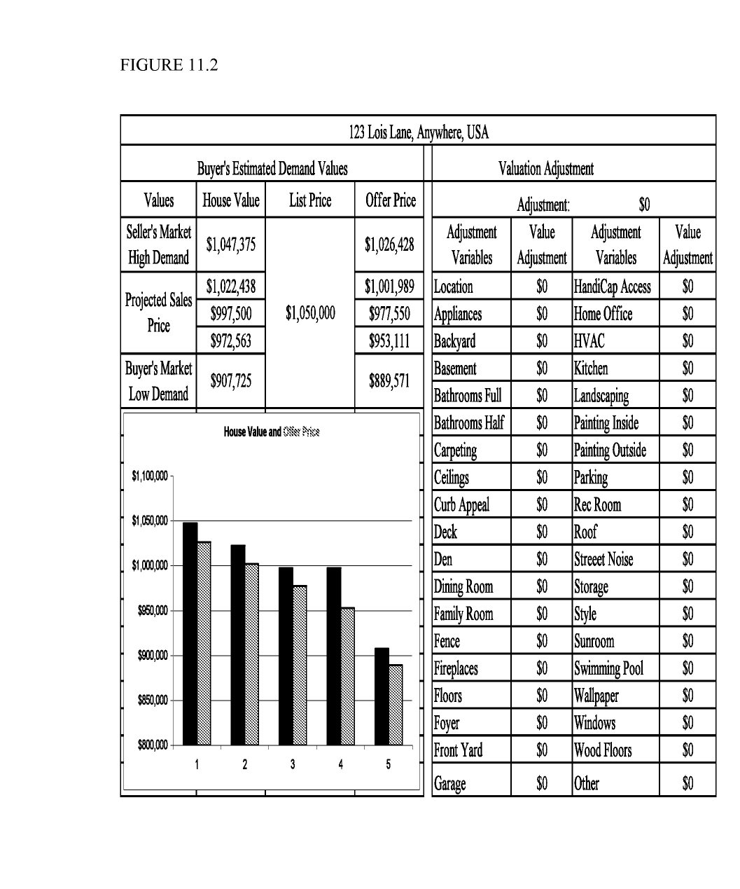

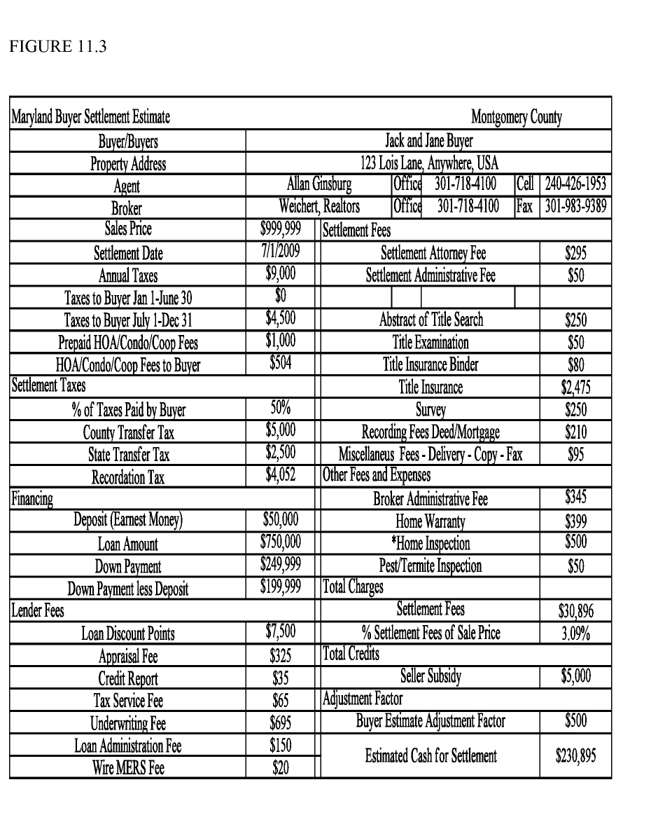

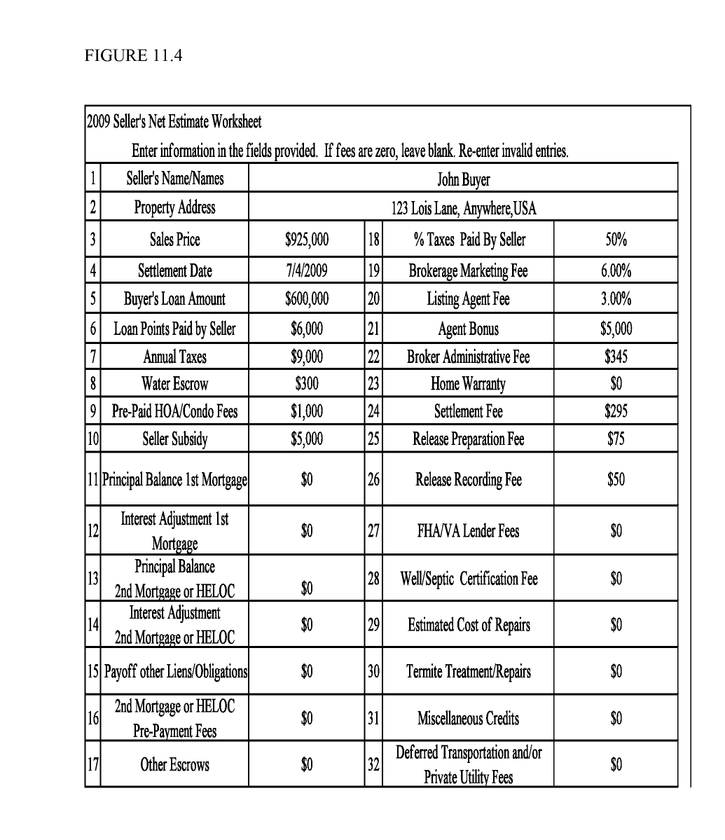

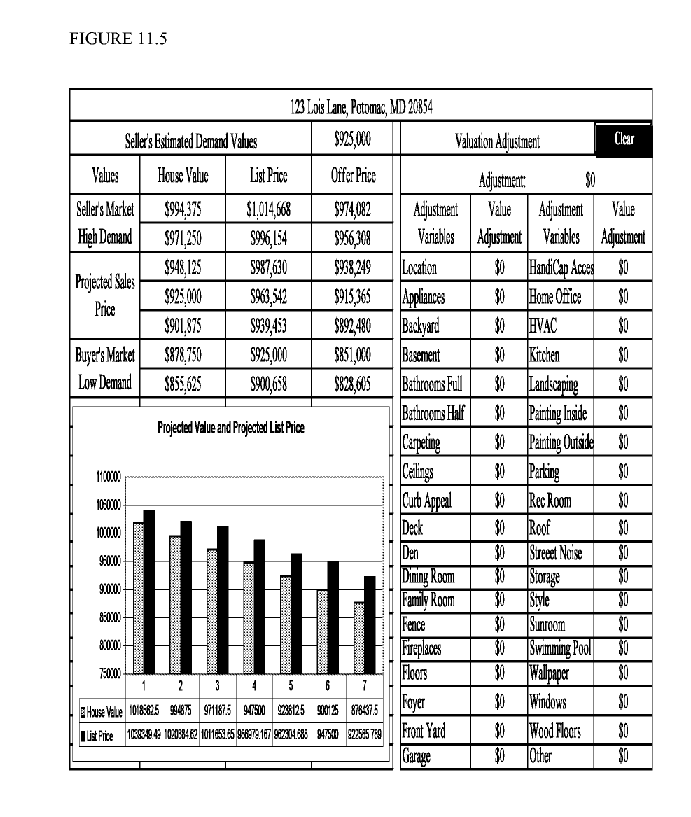

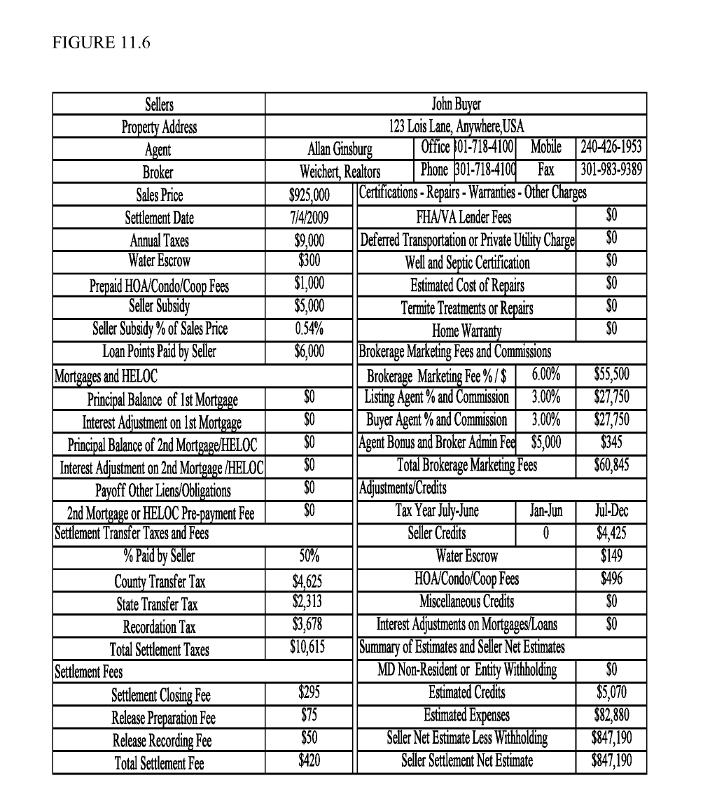

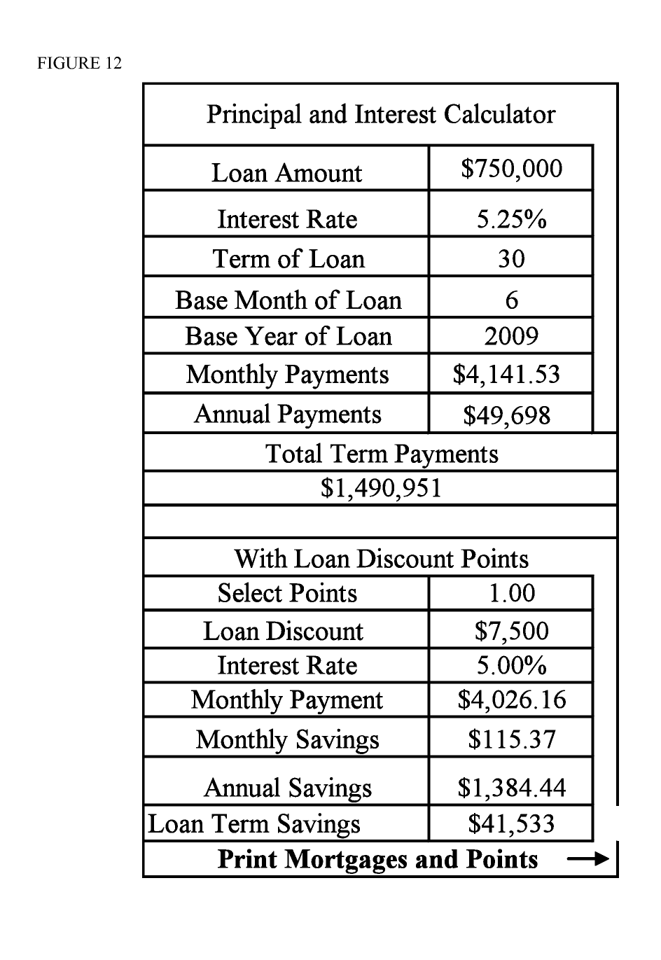

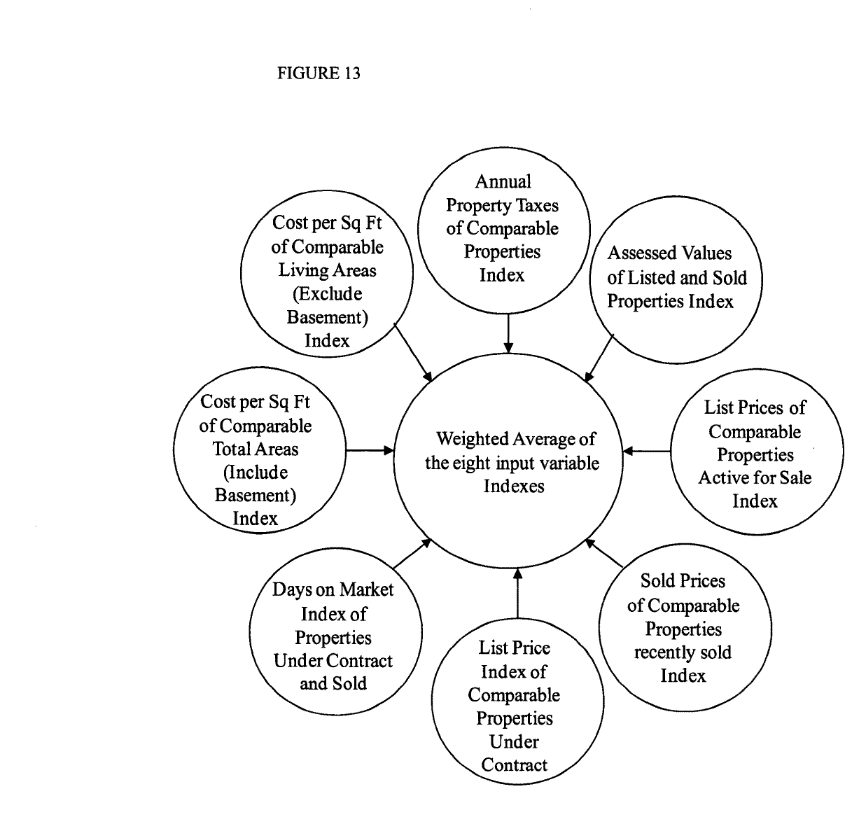

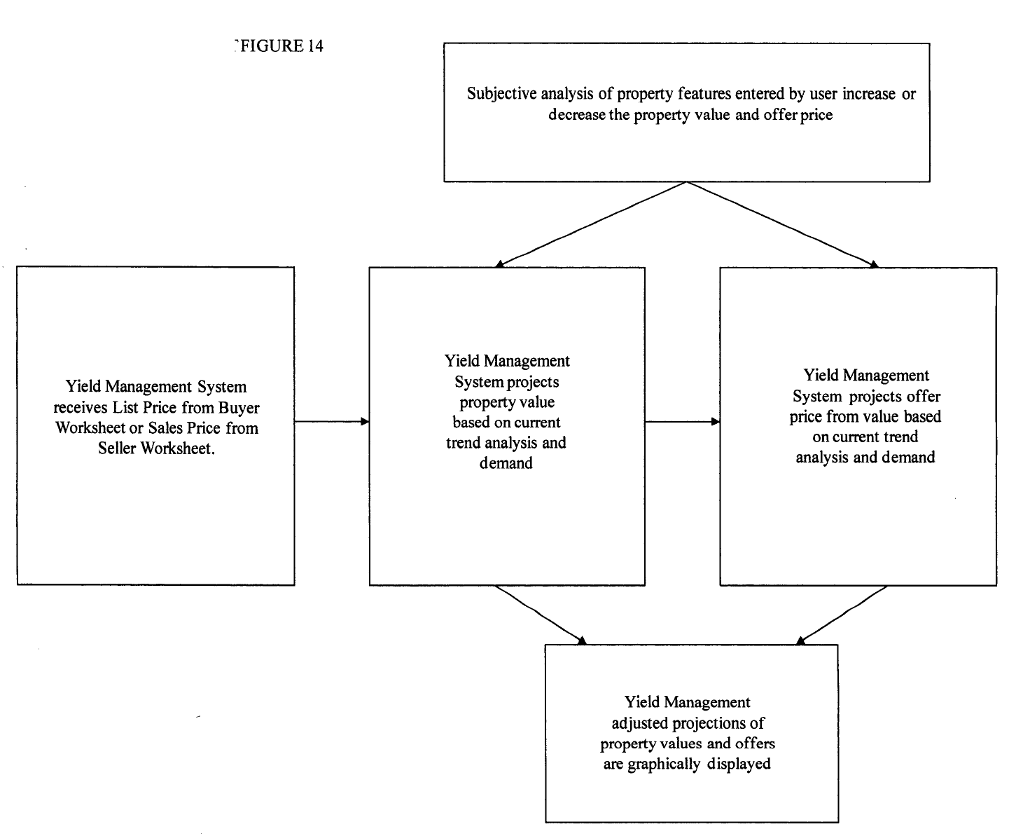

### DETAILED DESCRIPTION OF THE INVENTION

Described herein are methods and systems for providing integrated components to assist buyers and sellers of real estate in understanding multiple considerations when buying or selling real estate property. Informed buyers and sellers of real property increase the probability for the highest current demand value realized between all parties at any point in time. The system, Real-E-Stats, is a computer implemented software invention, which contains several modules including but not limited to: Settlement Estimates, Loan Point Buy Down Buyer or Seller Negotiation Estimates, Yield Management Forward and Backward Pricing, Listing, and Offer Engines, Automated Buyer, Seller, Renter, and Prospecting Data Capture and Processing Presentation Tools, a Property Valuation Index (PVI), and GPS Location and Data Delivery on Demand. The module “Real-E-Stats Settlement Estimates™” calculates the closing or settlement costs charged to real estate buyers or sellers to approximate the amount of cash required at “Closing” or “Settlement” by the buyer to complete the transaction, and the amount of cash, if any, the seller will net from the sell of the property. The invention minimizes the amount of information provided by a user while maximizing the output received to arrive at estimates that can be used to support the marketing and pricing of a seller's house, and enable buyers to plan around the economics, pricing, and fees associated with purchasing a house in order to negotiate the transaction and arrive at the settlement table with the cash necessary to complete the transaction. The Data Correction Module (DCM) over see's the data entries the user provides and offers mathematical corrections or considerations to verify the credibility of user entry. Modules in Real E-Stats require yield sensitive pricing calculations. The yield management application module provides unique pricing algorithms to present buyers and sellers multiple scenarios of pricing, value and offers based on property listing and value inputs and market demand fluctuations. The Property Value Index module provides multiple variable index processing including property active listings, contract, sold, tax assessment, annual taxes, total and living square footage, and time or days on the market to provide users with value projections that go beyond any single means of comparative analysis. To fully complete the buying and selling process, the invention connects the users to a variety of data sources. Multiple Listing Services (MLS) are widely used by members of the real estate industry as regional repositories of inventory. This invention uses this data in a variety of modules. Access of data is provided through a request transmitted to a real estate Multiple Listing Service (MLS) for processing and is returned to the system Web site or local computer application for presentation analysis and processing. The system compiles, aggregates, and organizes the data into a UI presentation including data reports, graphic displays, data explanations, data summaries, valuations and property value indexes and valuations. The agent selects print, file, or e-mail options for transmitting, delivering, or presenting the information to buyers, sellers or investors to support the client's decision-making process. The agent stores the processed information and system outputs on the Web site or local computer application for reference, updating, or comparative analysis. The component value of the system spans the entire selling and buying process from seller pricing, buyer qualification, prospecting, evaluation, offers and negotiations, serving the specific needs of sellers and buyers through the efforts of an agent to arrive at the most efficient and effective valuation and sale of residential or commercial real estate.

The premise for the Settlement Estimates module began as a request of an Agent by a Seller for an estimate of net cash after closing. Since there was not a simple way to prepare a document for estimating settlement charges, each individual fee and charge was researched and entered into a spreadsheet and the charges and credits were added and subtracted to arrive at a very rough estimate of seller net revenue. Understanding that the taxes charged by the county (Montgomery County, Maryland) varied according to the amount of the sale, and settlement dates impacted the amount of pre-paid expenses recaptured by the seller, complexity was added to the task of calculating a realistic estimate. It required much more time and effort than anticipated. Research identifying the input values to apply to the transaction cost required formulas to calculate county transfer taxes and credits. Hours later an estimate was available for the client. It had required a computer, internet connection, research, analytical skills and, programming and formatting skills, and most of all, valuable time to prepare the report in an industry where time is of the essence. Another agent saw the output report and asked if there was anything like it available for real estate buyers and investors. The need for a System enabling quick and easy access to settlement estimates for sellers, buyers, and investors of real estate had been identified by need. Research for an existing tool identified a void in the transaction process of selling and buying real estate. Two types of real estate transactional analysis existed, but neither served the initial need of either buyers or sellers; RESPA, the Real Estate Settlement Procedure Act required “Good Faith Estimates” prepared by mortgage companies when a loan application is received. The RESPA “Good Faith Estimate” is prepared only after the mortgage application is made. RESPA estimates are not prepared when Buyers request what is commonly referred to in real estate as a “Pre-Approval Letter” for financing. The “Pre-Approval” letter states that the buyer or buyers have been pre-qualified for a loan. It is not a guarantee for a loan, but is used and often attached to the contractual offer as an indication of financing approval in advance of application. The second transactional analysis is the HUD-1. It is the actual posting of charges and fees prepared by the Settlement Company, Agent, or Attorney prior to Settlement and accurate to the date of settlement or closing. Every fee and charge for both Buyer and Seller is included on the HUD-1, but the HUD-1 is delivered 24 to 72 hours prior to Settlement. From the time that a seller decides to sell and a buyer decides to buy, through all of the research, house hunting, Open House and appointment visits, and the compilation of comparative market analysis, through the offer, negotiation and ratification of the contract, there is a void of Settlement Estimates which enable sellers to do a better job of pricing their home, and buyer's a better job of qualification and negotiation. Whether negotiating for lower prices, subsidies, loan point discounts or improvements, Settlement Estimates enable Agents to educate their clients on what it takes to buy a home, and how much they will net when selling a property.

The Mortgage and Points Calculator

Ask an agent, buyer, or seller to explain :Buy Down Loan Points” and the answer is that they really aren't sure how they work. Agents, buyers and sellers know that buying down the mortgage rate through loan points reduce interest payments on mortgages but most cannot calculate the savings. Real-E=Stats answers the question with little input from the user. Users need only enter the length of the loan in years and the first month of the year that the mortgage payments commence. The Mortgage Calculator retrieves the mortgage amount from the buyer or seller input fields and calculates the monthly and annual mortgage payments. Users select “Loan Points” from a drop down menu and the system calculates the reduction in the mortgage interest rate and the reduction in monthly, annual, and total mortgage payments over the life of the loan. The value of the Mortgage and Points Calculator benefits the buyer by clearly demonstrating short and long term savings. It provides information useful to both the buying and selling agents on a negotiable benefit toward completing the contract. Sellers may agree to buy down the mortgage rates to make the property more attractive and affordable to the buyer. Buyers may use loan point buy downs in the contract negotiation to reduce monthly payments. The system enables users to calculate the value of advance interest payments and the amount of time necessary to recapture the investment. While mortgage calculators are not unique, combining the mortgage calculator with the Loan Point calculator offers a unique and automated tool to the transaction process. It requires no previous knowledge of the calculations or benefits that buying down the mortgage rate delivers to buyers, and offers users a valuable tool in negotiating the offer and contract.

Yield Management may be defined as getting the very best price at a specific point in time based on the current demand in a marketplace for a fixed inventory. Yield Management is used extensively in the marketing of broadcast inventory, hotel rooms, rental cars, cruise ship packages, and airline seats. As applied in the system, Yield Management is for the first time presented as a pricing tool or engine for determining the list price of a real estate property based on value, and anticipating or projecting the offer price. Yield Management, as used in the system, is expanded to work both forward and backward, a uniquely powerful and creative adaptation of the economic variables associated with the marketing and purchase of a property. Forward working, it converts the calculated value of a property to a demand curve that calculates a number of property demand values, listing prices, and anticipated offers. If demand is high, the value of a property increases as do the list prices and anticipated offer prices. High demand is often referred to in real estate as a “Seller's Market”. When demand is low, a “Buyer's Market”, values decrease as do the list and offer prices.

The first application of Yield Management, the forward adaptation, uses a system property value generated from a unique combination of indexing to create three demand curves or pricing grids; the Value Price, the List Price, and the Offer Price. The Offer Price is a projected sales price or property value anticipated by the Seller that begins the contract negotiation. Depending on the current demand in the marketplace, the Offer Price could be low, moderate or high. The system generated property value calculated by applying the PVI (Property Value Index) to the property List Price, considers eight weighted variables to determine value and demand:
1) List prices of similar properties for sale in the surrounding neighborhood or neighborhoods (hereto referred to as area)
2) Recently sold property prices in the area
3) List prices of properties currently Under Contract in the area
4) The Assessed Tax Values of the properties
5) Annual Property Taxes
6) Living Square Feet (the square feet of the property excluding the basement
7) Total Square Feet of the property including the basement.
8) Days on Market (DOM)
   The forward working yield management approach is designed to assist the agent and seller in the pricing of the property and enables the agent and seller to analyze scenarios associated with pricing a property in addition to anticipated offers and net revenue results of the pricing decision.

A new application of Yield Management, the backward application begins with the list price. It is the tool designed for the buyer. Utilizing the same PVI variables that the seller used in determining value to arrive at a list price, the backward application uses the list price to generate value and offers. Real-E=Stats itself is not a negotiation tool, but it generates the knowledge base and information that is used in the negotiation of the transaction between buyer and seller.

A third element is incorporated into the unique application of yield management to the real estate. Selling and buying a property is an emotional decision that often includes subjective variables. The impetus to make or accept an offer may not always be logical or analytical. Real-E-Stats and the pricing engine include a subjective module, the Value Adjustment Variable. The Value Adjustment Variable is a list of features ranging from location, curb appeal, room sizes, and other attributes that are each subjectively valued by the user to add or subtract from the computational value of the property. It can increase or decrease the property value based solely on the subjective interpretation of the user, but is ultimately designed to reduce the emotional impact of selling and buying by evaluating the incremental values of the property. The adjusted value is automatically incorporated by the system into the demand curve or price and value grids adjusting the outputs. MyRealEstats is a sub module of the Real-E-Stats system. MyRealEstats includes the following functionality:

1. Selling Module
a. The Selling Module captures comparative data on properties available for sale, sold, and under contract in a defined area and is captured from a Multiple Listing Service. The data is organized into reports, presented both numerically and graphically, and forwarded to the Property Value Index and Pricing Engine for the projection of Value, List, and Offer prices.

2. The Buying Module
a. Similar to the Pricing Module, the Buying Module also captures data from a Multiple Listing Service, but it's goal is to evaluate the property from the buyer's prospective to arrive at a value and offer price based upon historical sales and current comparative analysis and demand. While both the Selling and Buying Modules work toward the same middle ground, the sales price, the Buying Module places significant weight on comparing the historical value of sold properties and current comparative analysis of demand to assure that the buyer doesn't overpay for the property and has substantial and verifiable information to use in the contract negotiation.

3. The Rental Module
a. The Rental Module is a comparative analysis of Rental Properties. Utilizing the user or client's budget, data is extracted from the Multiple Listing Service and evaluated based on many of the same variables as the Buyer or Seller Modules in the pricing or offer for a property. Excluded from the Rental evaluations are variables such as Taxes and Assessed Values. A review of Rental Properties often shows little analytical logic in the pricing of a rental property. The primary determination of price often relies more on the monthly mortgage payment of the owner and potential cash flow to cover the monthly mortgage payment combined with the tax benefits of renting and depreciating the property, than an analysis of historical rental values in the area. The Rental Module is designed to capture rental opportunities in a specific area that can be viewed and considered by the user with calculations of area and property features that may be used in the rental negotiation process.

4. Prospecting Module
a. A Prospecting Module is incorporated into the system to identify owner contact information for properties that have Withdrawn and Expired Listings in the Multiple Listing Service. These properties may have been overpriced, poorly marketed, or simply not attracted offers during their initial listing agreement. Regardless of the reason, they did not sale and are no longer actively listed for sale. They are considered prospects and offer agents the opportunity to contact the owners to discuss the properties and the benefits they offer to earn the confidence of the seller and capture new business listings.

5. Financing and Home Services
a. The Financing and Home Services Module is where vendors may market their services. It is the embedded advertising vehicle associated with Real-E-Stats. It includes services such as financing, home inspections, contractors, engineers, moving and storage companies, HVAC contractors, pest inspectors, and other vendors who may find the users of Real-E-Stats as an effective advertising vehicle to increase business.

6. Wireless Links
a. The final Module associated with Real-E-Stats is the Wireless Link. Wireless Links enable users to receive information on hand held wireless devices on demand based on GPS location. The information can be pricing or subsets of the comparative analysis of the area enabling users to acquire timely knowledge on demand for specific properties that they may be driving or visiting.

In order to more fully understand the subject invention, below is a list of abbreviations and definitions that are used in the real estate industry.

Absorption Rate—the amount of inventory available for sale in a defined area divided by the amount of properties currently under contract in the defined area which yield the amount of time in months that it will take to sell the remaining unsold inventory. Absorption Rate identifies the demand for houses in a defined area.

Active—houses currently for sale

Advertised Subdivision—the name the area or community or development where a house is located

Agent—A Real Estate Agent or Salesperson

Assessment—the County assessed tax value of a property used to calculate taxes

BSMT—Basement

BR—Bedrooms in a house

Close Date—the date of settlement

Comps—Comparable houses

Contract—houses that are currently listed with accepted offers that have not yet gone to settlement

DOM—Days on Market—the amount of days that a house has been active for sale, or the amount of days that the house was on the market prior to being sold.

Sold—houses that have been listed, contracted for sale, closed.

Expired—properties whose listing has reached its end date and are no longer actives for sale

FB—Full Baths

Foreclosure—The lending institution's exercise of right to take ownership of a property due to lack of payment by the mortgagee.

FP—Fireplace

HB—Half Baths

HVAC—Heating, Ventilation and Air Conditioning

List Price—the asking price of a house listed for sale

Lot and Block—legal descriptions of the location of a property

LV—levels in a house including the basement

Multiple Listing Service (MLS)—The organization that captures property listings and maintains records of sales, withdrawals, and expirations of real property.

Settlement—Sometimes referred to as Closing, it the process where documents are signed and monies are exchanged in the sell and purchase of a property.

Short Sale—An owner who can no longer make mortgage payments has negotiated the sale of a property with the mortgage company at a price less than the outstanding mortgage to retire the debt. Short sales require third party approval.

Sold Price—the final Sales Price of a house

Third Party Approval—A Short Sale or Foreclosure that requires a third party, normally a bank or legal representative of financial company to approve or accept an offer to purchase.

Yield or Revenue Management—the process of generating the most money for a good or service based on the current state of the market demand.

Withdrawn—listings where sellers have requested that their properties be taken off the market for sale

What is claimed:

1. A computer implemented method of providing a user the ability to query a MLS (Multiple Listing Service) database to extract data necessary to evaluate the availability and value of real estate and real estate demand trends comprising of;
accessing a server through a client interface such as a Web site;
a user providing information relating to an existing or potential client's buying or selling criteria in order to create at least one residential or commercial data request;
transmitting the data request to a real estate Multiple Listing Service for processing and the data in which is returned to the system for presentation processing;
compiling, aggregating, and organizing the data into an agent Listing or Buyer presentation further comprising of,
reporting, graphical data modeling, data explanations, data summaries,
property value indexes, and valuation projections;
delivering the information to buyers, sellers or investors to support the client's decision making process.

2. The method of claim 1, wherein the information is real estate listing data for properties available for sale or lease, under contract, sold, rented, leased, expired, withdrawn or requiring third party approval of properties in a specifically defined state, county, zip code, advertised subdivision, legal subdivision, neighborhood, and street.

3. The method of claim 1, wherein the information comprises buyer or seller comparative criteria for evaluation.

4. The method of claim 1, wherein the information presented identifies properties that most closely represent the criteria associated with the seller's property or the buyer's criteria for comparative analysis.

5. The method of claim 1, wherein the information is compiled and processed into a Real Estate Agent Listing or Buyer presentation format.

6. The method of claim 1 wherein a time-weighted index consisting of the List Price, Sold Prices, List Price of Houses under Contract, Assessed Value, Annual Taxes, Living Sq Ft and Total Sq Ft, and Days on Market is created to present to buyers and sellers what might be a reasonable value for a Real Estate item against time for sale.

7. The method of claim 6 wherein the time-weighted index is created using
t=time in numbers of days
d=Days on Market (DOM)
l=list price of the real estate item being considered
ar=absorption rate of surrounding community

8. The method of claim 6 wherein a yield management system may be accessed to provide demand based cost analysis.

9. The method of claim 1, wherein the information is deliverable to clients in the form of printed or electronic formats.

10. The method of claim 1, wherein the information represented by the seller's or buyer's criteria is processed using statistical analysis projections and revenue or yield management calculations to present a projected value range of the seller's property or properties that meet the basic criteria of the buyer.

11. The method of claim 1, wherein the projected value of a property is adjusted to represent the condition and value of a property, including location, upgrades, downgrades, and maintenance requirements, based on the subjective evaluation by the agent, seller, and/or buyer and converted into values added to or subtracted from the statistical data analysis projection of comparable properties.

12. The method of claim 1, wherein the information is processed into professional reports, with graphic representations and a summary of the presentation proposal.

13. The method of claim 1, wherein the agent is provided with a customized seller or buyer presentation that the agent will use to demonstrate the agent's knowledge of the market and information necessary to position a client's property for sale, or identify and analyze prospective houses and values for a buyer.

14. The method of claim 1, wherein the valuation of properties utilizes market demand to adjust the value based on current trends and analysis including, but not limited to current and historical sales, the number of days a house has been on the market, the consumption or absorption rates, comparative values of properties sold and under contract and value indexes.

15. The method of claim 1, where an agent can evaluate properties that require third party approvals of offers to purchase.

16. The method of claim 1 where enterprise or high level users can be provided access to national, regional, and state analysis, trend, and demand reports.

17. The method of claim 1 wherein the users have security applied based on their attributes.

18. The implemented method of claim 1, wherein an agent can generate a projected seller of buyer's settlement report to evaluate the financial requirements and results of the transaction.

19. A computer implemented method for managing the real estate buying and selling process from inception to contract ratification, comprising of:
receiving a customer request for buying or selling a real estate item;
creating a real estate buying or selling proposal, that includes the real estate item's information based on user inputs from the real estate settlement estimate tool;
accessing one or more external applications to integrate with the information and data from the settlement estimate tool;
storing the real estate settlement estimate in a database connected with the real estate analysis tool;
providing user management and reporting of stored settlement estimates.

20. The method of claim 19 wherein creating a settlement estimate includes receiving buying criteria.

21. The method of claim 19 wherein creating a settlement estimate includes receiving selling criteria.

22. The method of claim 19 can further comprise of aggregating data from multiple disparate data sources.

23. The method of claim 22 wherein the data is processed to present multiple views of associated costs and opportunities involved in the transaction.

24. The method of claim 19 further comprising of location awareness data during user input for a settlement estimate.

25. The method of claim 24 wherein location specific data is stored in a database.

26. The method of claim 24 wherein location awareness systems such as a GPS may be accessed.

27. The method of claim 19 wherein multiple scenarios can be built for the same real estate item and presented to the buying or selling real estate customer.

28. The method of claim 19 wherein a yield management system can be accessed to generate multiple buying and selling price scenarios and present them to the users.

29. The method of claim 19 wherein a loan payment and loan buy down calculator can be accessed during the scenario building process.

30. A computer implemented system of providing a user the ability to query a MLS (Multiple Listing Service) databases to extract data necessary to evaluate the availability and value of real estate and real estate demand trends comprising of;
accessing a server through a client interface such as a Web site;
a user providing information relating to an existing or potential client's buying or selling criteria in order to create at least one residential or commercial data request;
transmitting the data request to a real estate Multiple Listing Service for processing and the data is returned to the system for presentation processing;
compiling, aggregating, and organizing the data into an agent Listing or Buyer presentation further comprising of,
reporting, graphical data modeling, data explanations, data summaries,
property value indexes, and valuation projections;
delivering the information to buyers, sellers or investors to support the client's decision making process.

31. The system of claim 30, wherein the information is real estate listing data for properties available for sale or lease, under contract, sold, rented, leased, expired, withdrawn or requiring third party approval of properties in a specifically defined state, county, zip code, advertised subdivision, legal subdivision, neighborhood, and street.

32. The system of claim 30, wherein the information comprises buyer or seller comparative criteria for evaluation.

33. The system of claim 30, wherein the information presented identifies properties that most closely represent the criteria associated with the seller's property or the buyer's criteria for comparative analysis.

34. The system of claim 30, wherein the information is compiled and processed into a Real Estate Agent Listing or Buyer presentation format.

35. The system of claim 30 wherein a time-weighted index including List Price, Sold Prices, List Price of Houses under Contract, Assessed Value, Annual Taxes, Living Sq Ft and Total Sq Ft, and Days on Market is created to present to buyers and sellers what might be a reasonable value price for a Real Estate item against time for sale.

36. The system of claim 35 wherein the time-weighted index is created using
t=time in numbers of days
d=Days on Market (DOM)
l=list price of the real estate item being considered
ar=absorption rate of surrounding community

37. The system of claim 35 wherein a yield management system may be accessed to provide demand based cost analysis.

38. The system of claim 30, wherein the information is deliverable to clients in the form of printed or electronic formats.

39. The system of claim 30, wherein the information represented by the seller's or buyer's criteria is processed using statistical analysis projections and revenue or yield management calculations to present a projected value range of the seller's property or properties that meet the basic criteria of the buyer.

40. The system of claim 30, wherein the projected value of a property is adjusted to represent the condition and value of a property, including location, upgrades, downgrades, and maintenance requirements, based on the subjective evaluation by the agent, seller, and/or buyer and converted into values added to or subtracted from the statistical data analysis projection of comparable properties.

41. The system of claim 30, wherein the information is processed into professional reports, with graphic representations and a summary of the presentation proposal.

42. The system of claim 30, wherein the agent is provided with a customized seller or buyer presentation that the agent will use to demonstrate the agent's knowledge of the market and information necessary to position a client's property for sale, or identify and analyze prospective houses and values for a buyer.

43. The system of claim 30, wherein the valuation of properties utilizes market demand to adjust the value based on current trends and analysis including, but not limited to current and historical sales, the number of days a house has been on the market, the consumption or absorption rates, comparative values of properties sold and under contract and value indexes.

44. The system of claim 30, where an agent can evaluate properties that require third party approvals of offers to purchase.

45. The system of claim 30 where enterprise or high level users can be provided access to national, regional, and state analysis, trend, and demand reports.

46. The system of claim 30 wherein the users have security applied based on their attributes.

47. The system of claim 30, wherein an agent can generate a projected seller of buyer's settlement report to evaluate the financial requirements and results of the transaction.

48. A computer implemented system for managing the real estate buying and selling process from inception to contract ratification, comprising of:
receiving a customer request for buying or selling a real estate item;
creating a real estate buying or selling proposal, that includes the real estate item's information based on user inputs from the real estate settlement estimate tool;
accessing one or more external applications to integrate the information and data into the settlement estimate tool;
storing the real estate settlement estimate in a database connected with the real estate settlement estimate tool;
providing user management and reporting of stored settlement estimates.

49. The system of claim 48 that can further comprise the aggregating of data from multiple disparate data sources.

50. The system of claim 48 wherein the data is processed to present multiple views of associated costs and opportunities involved in the transaction.

51. The system of claim 48 further comprising of location awareness data during user input for a settlement estimate.

52. The system of claim 51 wherein location specific data is stored in a database.

53. The system of claim 51 wherein location awareness systems such as a GPS may be accessed.

54. The system of claim 48 wherein multiple scenarios can be built for the same real estate item and presented to the buying or selling real estate customer.

55. The system of claim 48 that contains a yield management subsystem to generate multiple buying and selling price scenarios for presentation to buyers or sellers.

56. The system of claim 48 that contains a loan payment and loan point buy down calculator.
